(19) United States
(12) Patent Application Publication
(10) Pub. No.: US 2025/0052582 A1
(43) Pub. Date: Feb. 13, 2025

(54) LANE POSITIONING METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventor: Ning XIAO, Shenzhen (CN)

(21) Appl. No.: 18/921,698

(22) Filed: Oct. 21, 2024

Related U.S. Application Data
(63) Continuation of application No. PCT/CN2023/123985, filed on Oct. 11, 2023.

(30) Foreign Application Priority Data
Nov. 17, 2022 (CN) 202211440211.8

(51) Int. Cl. G01C 21/30; G06V 20/56

(52) U.S. Cl. CPC G01C 21/30; G06V 20/588

(57) ABSTRACT

A lane positioning method includes: obtaining a road visible region corresponding to a target vehicle, the road visible region being related to the target vehicle and a component parameter of a photographing component installed on the target vehicle, and being a road location photographed by the photographing component; obtaining, according to vehicle location status information of the target vehicle and the road visible region, local map data associated with the target vehicle, the road visible region being located in the local map data; the local map data including at least one lane associated with the target vehicle; and determining, from the at least one lane of the local map data, a target lane to which the target vehicle belongs.

### CROSS-REFERENCES TO RELATED APPLICATIONS

This application is a continuation application of PCT Patent Application No. PCT/CN2023/123985, filed on Oct. 11, 2023, which claims priority to Chinese Patent Application No. 202211440211.8, filed on Nov. 17, 2022, which is incorporated by reference in its entirety.

### FIELD OF THE TECHNOLOGY

The present disclosure relates to the field of computer technologies and, in particular, to a lane positioning method and apparatus, a computer device, a computer readable storage medium, and a computer program product.

### BACKGROUND OF THE DISCLOSURE

A lane positioning method may be used to obtain a vehicle location point of a target vehicle, obtain map data from global map data based on the vehicle location point as a center of a circle (that is, obtaining map data using the target vehicle as the center), and then determine a target lane, to which the target vehicle belongs, in the obtained map data. For example, map data may be obtained in a circle centered at the target vehicle with a radius of 5 meters. However, when the target vehicle drives in a region (for example, a region at an intersection, a convergence entrance, or a driving exit) in which a lane line color or a lane line pattern type (or a lane line type) changes drastically, map data obtained using the current lane positioning method is often quite different from visually-seen map data. Consequently, incorrect map data, which does not match the visually-observed map data, may be used for driving. The incorrect map data makes it impossible to accurately obtain the target lane to which the target vehicle belongs, thereby reducing accuracy rate of lane-level positioning.

### SUMMARY

One aspect of the embodiments of the present disclosure provides a lane positioning method, performed by a computer device. The method includes: obtaining a road visible region corresponding to a target vehicle, the road visible region being related to the target vehicle and a component parameter of a photographing component installed on the target vehicle, and being a road location photographed by the photographing component; obtaining, according to vehicle location status information of the target vehicle and the road visible region, local map data associated with the target vehicle, the road visible region being located in the local map data, and the local map data comprising at least one lane associated with the target vehicle; and determining, from the at least one lane of the local map data, a target lane to which the target vehicle belongs.

Another aspect of the embodiments of the present disclosure provides a computer device. The computer device includes at least one processor and a memory storing a computer program that, when being executed, causes the at least one processor to perform: obtaining a road visible region corresponding to a target vehicle, the road visible region being related to the target vehicle and a component parameter of a photographing component installed on the target vehicle, and being a road location photographed by the photographing component; obtaining, according to vehicle location status information of the target vehicle and the road visible region, local map data associated with the target vehicle, the road visible region being located in the local map data, and the local map data comprising at least one lane associated with the target vehicle; and determining, from the at least one lane of the local map data, a target lane to which the target vehicle belongs.

Another aspect of the embodiments of the present disclosure provides a non-transitory computer readable storage medium containing a computer program that, when being executed, causes one or more processors of a computer device to perform: obtaining a road visible region corresponding to a target vehicle, the road visible region being related to the target vehicle and a component parameter of a photographing component installed on the target vehicle, and being a road location photographed by the photographing component; obtaining, according to vehicle location status information of the target vehicle and the road visible region, local map data associated with the target vehicle, the road visible region being located in the local map data, and the local map data comprising at least one lane associated with the target vehicle; and determining, from the at least one lane of the local map data, a target lane to which the target vehicle belongs.

### BRIEF DESCRIPTION OF THE DRAWINGS

FIG. 1 is a schematic structural diagram of a network architecture according to an embodiment of the present disclosure.

FIG. 2 is a schematic diagram of a data exchange scenario according to an embodiment of the present disclosure.

FIG. 3 is a schematic flowchart of a lane positioning method according to an embodiment of the present disclosure.

FIG. 4 is a schematic diagram of a camera modeling scenario according to an embodiment of the present disclosure.

FIG. 5 is a schematic diagram of a scenario in which a road visible point distance is determined according to an embodiment of the present disclosure.

FIG. 6 is a schematic diagram of a scenario in which a road visible point distance is determined according to an embodiment of the present disclosure.

FIG. 7 is a schematic flowchart of lane-level positioning according to an embodiment of the present disclosure.

FIG. 8 is a schematic flowchart of a lane positioning method according to an embodiment of the present disclosure.

FIG. 9 is a schematic diagram of a scenario in which a lane line is identified according to an embodiment of the present disclosure.

FIG. 10 is a schematic diagram of a vehicle coordinate system according to an embodiment of the present disclosure.

FIG. 11 is a schematic diagram of a scenario in which region division is performed according to an embodiment of the present disclosure.

FIG. 12 is a schematic structural diagram of a lane positioning apparatus according to an embodiment of the present disclosure.

FIG. 13 is a schematic structural diagram of a computer device according to an embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

Embodiments of the present disclosure provide a lane positioning method and apparatus, a computer device, a computer readable storage medium, and a computer program product, with improved accuracy of positioning a target lane to which a target vehicle belongs.

In the embodiments of the present disclosure, related data such as user information is involved. When the embodiments of the present disclosure are applied to a specific product or technology, a user's permission or consent needs to be obtained, and related data collection, use, and processing need to comply with relevant laws and standards of a relevant country and region.

Artificial intelligence (AI) is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, machine learning (ML)/deep learning, automated driving, and intelligent transportation.

The ITS, also referred to as an intelligent transportation system, effectively integrates advanced science and technologies (for example, an information technology, a computer technology, a data communication technology, a sensor technology, an electronic control technology, an automatic control theory, operational research, and artificial intelligence) into transportation, service control, and vehicle manufacturing, and strengthens a relationship among a vehicle, a road, and a user, so as to form an integrated transport system that ensures safety, improves efficiency, improves environment, and saves energy.

An intelligent vehicle infrastructure cooperative system (IVICS) is a development direction of the ITS. The vehicle infrastructure cooperative system adopts advanced wireless communication and new-generation Internet technologies to implement dynamic real-time information interaction between vehicles and between a vehicle and an infrastructure in an all-round way, and implements vehicle active safety control and road cooperative management on the basis of full-time-space and dynamic traffic information collection and integration, to fully realize effective cooperation between pedestrian, vehicles, and roads, ensure traffic safety, and improve traffic efficiency, thereby forming a safe, efficient, and environmental road transportation system.

Map data may include standard definition (SD) data, high definition (HD) data, and lane-level data. The SD data is common road data, and mainly records a basic attribute of a road, for example, a road length, a quantity of lanes, a direction, and lane topology information. The HD data is high-precision road data, and records accurate and rich road information, for example, a road lane line equation/shape point coordinates, a lane type, a lane speed limit, a lane marking type, pole coordinates, a fingerpost location, a camera, and a traffic light location. The lane-level data is richer than the SD data but does not reach a specification of the SD data, and includes lane-level information of a road, for example, a road lane line equation/shape point coordinates, a lane type, a lane speed limit, a lane marking type, and lane topology information. The map data does not directly store the road lane line equation, but uses shape point coordinates to fit a road shape.

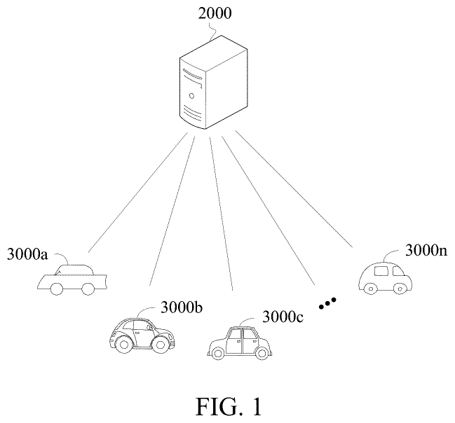

Specifically, FIG. 1 is a schematic structural diagram of a network architecture according to an embodiment of the present disclosure. As shown in FIG. 1, the network architecture may include a server 2000 and an in-vehicle terminal cluster. The in-vehicle terminal cluster may specifically include at least one in-vehicle terminal, and a quantity of in-vehicle terminals in the in-vehicle terminal cluster is not limited herein. As shown in FIG. 1, a plurality of in-vehicle terminals may specifically include an in-vehicle terminal 3000a, an in-vehicle terminal 3000b, an in-vehicle terminal 3000c, . . . , and an in-vehicle terminal 3000n. The in-vehicle terminal 3000a, the in-vehicle terminal 3000b, the in-vehicle terminal 3000c, . . . , and the in-vehicle terminal 3000n may separately establish a network connection to the server 2000, so that each in-vehicle terminal can perform data interaction with the server 2000 by using the network connection. Similarly, a communication connection may exist between the in-vehicle terminal 3000a, the in-vehicle terminal 3000b, the in-vehicle terminal 3000c, . . . , and the in-vehicle terminal 3000n, to implement information exchange. For example, a communication connection may exist between the in-vehicle terminal 3000a and the in-vehicle terminal 3000b.

Each in-vehicle terminal in the in-vehicle terminal cluster may be an intelligent driving vehicle, or may be an autonomous driving vehicle of a different level. In addition, a vehicle type of each in-vehicle terminal includes but is not limited to a car, a medium-sized vehicle, a large-sized vehicle, a cargo vehicle, an ambulance, a fire fighting vehicle, and the like. This embodiment of the present disclosure sets no limitation on the vehicle type of the in-vehicle terminal.

An application client with a lane positioning function may be installed on each in-vehicle terminal in the in-vehicle terminal cluster shown in FIG. 1. When the application client runs on each in-vehicle terminal, data exchange may be separately performed with the server 2000 shown in FIG. 1. For case of understanding, in this embodiment of the present disclosure, one in-vehicle terminal may be selected from the plurality of in-vehicle terminals shown in FIG. 1 as a target in-vehicle terminal. For example, in this embodiment of the present disclosure, the in-vehicle terminal 3000b shown in FIG. 1 may be used as a target in-vehicle terminal. For case of understanding, in this embodiment of the present disclosure, the target in-vehicle terminal may be referred to as a target vehicle. An application client with a lane positioning function may be installed in the target vehicle. The target vehicle may exchange data with the server 2000 by using the application client.

The server 2000 may be a server corresponding to the application client. The server 2000 may be an independent physical server, or may be a server cluster or a distributed system formed by a plurality of physical servers, or may be a cloud server that provides basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

A computer device in this embodiment of the present disclosure may obtain a nearest road visible point corresponding to a target vehicle, obtain, from global map data according to vehicle location status information of the target vehicle and a road visible region (for example, the nearest road visible point, which may be referred to as a first ground visible point in this embodiment of the present disclosure), local map data associated with the target vehicle, and further determine, from at least one lane of the local map data, a target lane to which the target vehicle belongs. The nearest road visible point is determined by the target vehicle and a component parameter of a photographing component, and the photographing component installed on the target vehicle is configured to photograph a road of the target vehicle in a driving direction. The nearest road visible point is a road location that is closest to the target vehicle and photographed by the photographing component, and the nearest road visible point is located in the local map data.

The lane positioning method provided in this embodiment of the present disclosure may be performed by the server 2000 (that is, the foregoing computer device may be the server 2000), may be performed by the target vehicle (that is, the foregoing computer device may be the target vehicle), or may be performed jointly by the server 2000 and the target vehicle. For case of understanding, in this embodiment of the present disclosure, a user corresponding to the target vehicle may be referred to as a target object.

When the lane positioning method is jointly performed by the server 2000 and the target vehicle, the target object may send a lane positioning request to the server 2000 by using an application client in the target vehicle. The lane positioning request may include the nearest road visible point corresponding to the target vehicle and the vehicle location status information of the target vehicle. In this way, the server 2000 may obtain, from the global map data, the local map data associated with the target vehicle according to the vehicle location status information and the nearest road visible point, for returning the local map data to the target vehicle, so that the target vehicle determines the target lane from the at least one lane of the local map data.

For example, when the lane positioning method is performed by the server 2000, the target object may send a lane positioning request to the server 2000 by using an application client in the target vehicle. The lane positioning request may include a road visible region (for example, a nearest road visible point) corresponding to the target vehicle and vehicle location status information of the target vehicle. In this way, the server 2000 may obtain, from the global map data, the local map data associated with the target vehicle according to the vehicle location status information and the nearest road visible point, for determining the target lane from the at least one lane of the local map data, and returning the target lane to the target vehicle.

For example, when the lane positioning method is performed by the target vehicle, the target vehicle may obtain, from the global map data, the local map data associated with the target vehicle according to the nearest road visible point corresponding to the target vehicle and the vehicle location status information of the target vehicle, for determining the target lane from the at least one lane of the local map data. The global map data is obtained by the target vehicle from the server 2000. The target vehicle may obtain the global map data offline from a vehicle local database, or may obtain the global map data online from the server 2000. The global map data in the vehicle local database may be obtained by the target vehicle from the server 2000 at a previous moment of a current moment.

For example, the lane positioning method provided in this embodiment of the present disclosure may be further performed by a target terminal device corresponding to the target object. The target terminal device may include an intelligent terminal that has a lane positioning function such as a smartphone, a tablet computer, a notebook computer, a desktop computer, an intelligent voice interaction device, a smart home appliance (for example, a smart TV), a wearable device, and an aircraft. The target terminal device may establish a direct or indirect network connection to the target vehicle in a wired or wireless communication manner. Similarly, an application client with a lane positioning function may be installed in the target terminal device, and the target terminal device may perform data interaction with the server 2000 by using the application client. For example, when the target terminal device is a smartphone, the target terminal device may obtain, from the target vehicle, the nearest road visible point corresponding to the target vehicle and the vehicle location status information corresponding to the target vehicle, obtain the global map data from the server 2000, obtain, from the global map data, the local map data associated with the target vehicle according to the vehicle location status information and the nearest road visible point, and determine the target lane from the at least one lane of the local map data. In this case, the target terminal device may display, in the application client, the target lane to which the target vehicle belongs.

The embodiments of the present disclosure may be applied to scenarios such as a cloud technology, artificial intelligence, intelligent transportation, an intelligent vehicle control technology, automatic driving, aided driving, map navigation, and lane positioning. As a quantity of in-vehicle terminals continuously increases, application of map navigation becomes more and more widespread. Lane-level positioning (that is, determining a target lane to which a target vehicle belongs) of a vehicle in a map navigation scenario is very important. Lane-level positioning is of great significance for a vehicle to determine a horizontal location at which the vehicle is located and formulate a navigation policy. In addition, a result of lane-level positioning (that is, positioning the target lane) may be further configured for lane-level path planning and guiding. On the one hand, a vehicle passing rate of an existing road network can be increased, traffic congestion can be alleviated, vehicle driving safety can be improved, a traffic accident rate can be reduced, traffic safety can be improved, energy consumption can be reduced, and environmental pollution can be reduced.

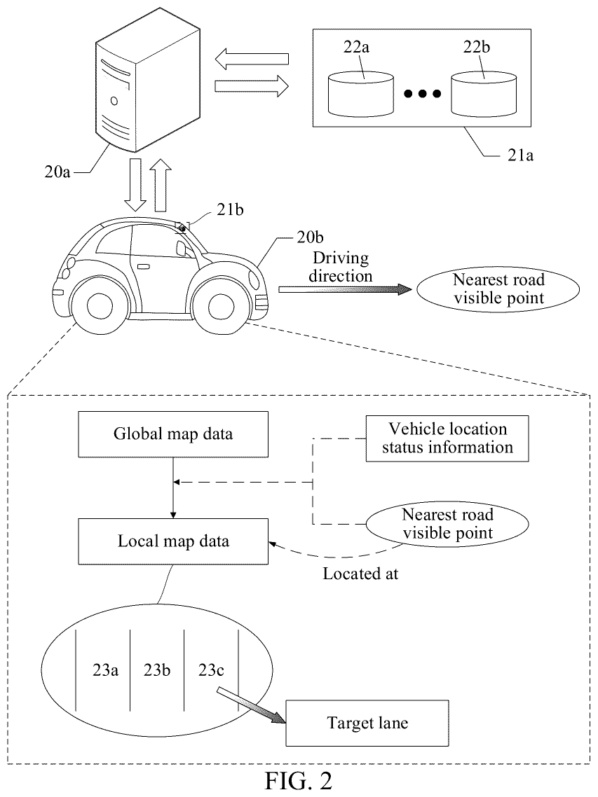

FIG. 2 is a schematic diagram of a data exchange scenario according to an embodiment of the present disclosure. A server 20a shown in FIG. 2 may be the server 2000 in the embodiment corresponding to FIG. 1, and a target vehicle 20b shown in FIG. 2 may be the target in-vehicle terminal in the embodiment corresponding to FIG. 1. A photographing component 21b may be installed on the target vehicle 20b, and the photographing component 21b may be a camera that is on the target vehicle 20b and that is configured for photographing. For case of understanding, an example in which the lane positioning method is performed by the target vehicle 20b is configured for description in this embodiment of the present disclosure.

As shown in FIG. 2, the target vehicle 20b may obtain a road visible region (for example, a nearest road visible point) corresponding to the target vehicle 20b. The nearest road visible point is determined by the target vehicle 20b and a component parameter of the photographing component 21b. The photographing component 21b installed on the target vehicle 20b may be configured to photograph a road of the target vehicle 20b in a driving direction. The driving direction of the target vehicle 20b may be shown in FIG. 2. The nearest road visible point is in the driving direction of the target vehicle 20b, and the nearest road visible point is a road location that is photographed by the photographing component 21b and that is closest to the target vehicle 20b.

As shown in FIG. 2, the target vehicle 20b may send a map data obtaining request to the server 20a. In this way, after receiving the map data obtaining request, the server 20a may obtain, from a map database 21a, global map data associated with the target vehicle 20b. A range of the global map data associated with the target vehicle 20b is not limited in this embodiment of the present disclosure. The map database 21a may be separately disposed, or may be integrated into the server 20a, or integrated into another device or cloud, which is not limited herein. The map database 21a may include a plurality of databases, and the plurality of databases may specifically include: a database 22a, . . . , and a database 22b.

The database 22a, . . . , and the database 22b may be configured for storing map data of different countries. The map data in the database 22a, . . . , and the database 22b is generated and stored by the server 20a. For example, the database 22a may be configured to store map data of country G₁, and the database 22b may be configured to store map data of country G₂. In this way, if the country in which the target vehicle 20b is located is country G₁, the server 20a may obtain the map data of country G₁ from the database 22a, and determine the map data of country G₁ as the global map data associated with the target vehicle 20b (that is, the range of the global map data associated with the target vehicle 20b is a country). In some embodiments, the global map data associated with the target vehicle 20b may further be map data of a city in which the target vehicle 20b is located. In this case, the server 20a may obtain the map data of country G₁ from the database 22a, and further obtain the map data of the city in which the target vehicle 20b is located from the map data of country G₁, and determine the map data of the city in which the target vehicle 20b is located as the global map data associated with the target vehicle 20b (that is, the range of the global map data associated with the target vehicle 20b is a city). The range of the global map data is not limited in this embodiment of the present disclosure.

In some embodiments, as shown in FIG. 2, after obtaining the global map data associated with the target vehicle 20b, the server 20a may return the global map data to the target vehicle 20b. In this way, the target vehicle 20b may obtain, from the global map data, local map data associated with the target vehicle 20b according to vehicle location status information of the target vehicle 20b and the nearest road visible point. The nearest road visible point is located in the local map data, and the local map data belongs to the global map data. In other words, both the local map data and the global map data are map data associated with the target vehicle 20b, and the range of the global map data is greater than a range of the local map data. For example, the global map data is map data of a city in which the target vehicle 20b is located, and the local map data is map data of a street in which the target vehicle 20b is located.

In addition, the local map data may be lane-level data of a local region (for example, a street). In some embodiments, the local map data may be SD data of the local region, or may be HD data of the local region. This is not limited in the present disclosure. Likewise, the global map data may be lane-level data of a global region (for example, a city). In some embodiments, the global map data may be SD data of the global region, or may be HD data of the global region. This is not limited in the present disclosure. For case of understanding, in this embodiment of the present disclosure, for example, the local map data is used as lane-level data for description. When the local map data is lane-level data, in the present disclosure, the target lane to which the target vehicle 20b belongs may be determined by using the lane-level data, and the target lane to which the target vehicle 20b belongs does not need to be determined by using high-precision data (that is, HD data). In addition, the photographing component 21b installed on the target vehicle 20b may be configured for determining the nearest road visible point. Therefore, an impact factor considered in the lane-level positioning solution provided in this embodiment of the present disclosure may reduce technology costs, thereby better supporting mass production.

The vehicle location status information may include a vehicle location point of the target vehicle 20b and a vehicle driving state of the target vehicle 20b on the vehicle location point, the vehicle location point may be coordinates formed by longitude and latitude, and the vehicle driving state may include but is not limited to a driving speed (that is, vehicle speed information), a driving heading angle (that is, vehicle heading angle information), and the like of the target vehicle 20b.

As shown in FIG. 2, the local map data may include at least one lane associated with the target vehicle 20b. In this embodiment of the present disclosure, a quantity of lanes in the local map data is not limited. For case of understanding, that the quantity of lanes in the local map data is 3 is used as an example herein for description, and the three lanes may include a lane 23a, a lane 23b, and a lane 23c. Further, the target vehicle 20b may determine, from the three lanes of the local map data, the target lane to which the target vehicle 20b belongs (that is, a lane driving by the target vehicle 20b). For example, the target lane to which the target vehicle 20b belongs may be the lane 23c.

It can be learned that, in this embodiment of the present disclosure, the local map data may be obtained from the global map data by comprehensively considering the nearest road visible point corresponding to the target vehicle and the vehicle location status information of the target vehicle. Because the nearest road visible point is a road location that is closest to the target vehicle and photographed by the photographing component, the local map data generated based on the nearest road visible point matches the vision of the target vehicle, so that accuracy of the obtained local map data can be improved, and when the target lane to which the target vehicle belongs is determined from the local map data with high accuracy, accuracy of locating the target lane to which the target vehicle belongs can be improved. In a driving (for example, self-driving) scenario of a city road, a road change is extremely complex, and a lane line color or a lane line pattern type change is more severe in regions such as an intersection, a convergence entrance, and a driving exit. By analyzing the nearest road visible point, it can be ensured that the obtained local map data better covers these complex road conditions, and accuracy of lane-level positioning is improved in a process of locating the target lane in a complex road condition, thereby providing better and safer self-driving for the city road.

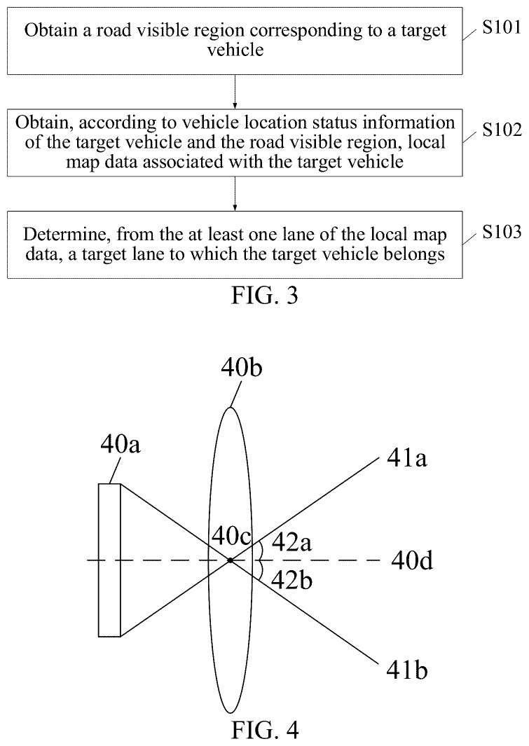

In some embodiments, referring to FIG. 3, FIG. 3 is a schematic flowchart of a lane positioning method according to an embodiment of the present disclosure. The method may be performed by a server, or may be performed by an in-vehicle terminal, or may be jointly performed by a server and an in-vehicle terminal. The server may be the server 20a in the embodiment corresponding to FIG. 2, and the in-vehicle terminal may be the target vehicle 20b in the embodiment corresponding to FIG. 2. For case of understanding, this embodiment of the present disclosure uses an example in which the method is performed by an in-vehicle terminal for description. The lane positioning method may include the following operation S101 to operation S103:

In operation S101, obtain a road visible region corresponding to a target vehicle.

The road visible region may be related to the target vehicle and a component parameter of a photographing component installed on the target vehicle, and is a road location photographed by the photographing component. That is, the road visible region refers to a region in which a road on which the target vehicle photographed by the photographing component drives falls within a range of the viewing angle of the photographing component. In addition, the road visible region may be further divided into a nearest road visible point and a nearest road visible region according to photographing precision of the photographing component. For example, a road pixel that is closest to the target vehicle and that is in a photographed road image of the photographing component may be used as a nearest road visible point, or a road image photographed by the photographing component may be divided according to a preset size (for example, 5*5 pixels), to obtain a plurality of road grids. Then, a road grid that is closest to the target vehicle and that is in the plurality of road grids is used as a nearest road visible region, that is, in this embodiment of the present disclosure, a road pixel in the road image may be used as a road visible region, or a road grid in the road image may be used as a road visible region.

For example, the road visible region is the nearest road visible point. The nearest road visible point may be determined by the target vehicle and the component parameter of the photographing component. The photographing component installed on the target vehicle is configured to photograph the road of the target vehicle in the driving direction. The nearest road visible point is a road location that is photographed by the photographing component and that is closest to the target vehicle. In other words, a nearest ground location that can be seen by the photographing component installed on the target vehicle in the photographed road image is referred to as the nearest road visible point, and the nearest road visible point is also referred to as a first ground visible point (that is, a ground visible point seen from a first viewing angle of the target vehicle), which is referred to as a first visible point.

A specific process of determining the nearest road visible point according to the target vehicle and the component parameter may be described as follows: determining, according to the component parameter of the photographing component, M photographing boundary lines corresponding to the photographing component; where M herein may be a positive integer; and the M photographing boundary lines include a lower boundary line, and the lower boundary line is a boundary line closest to a road in the M photographing boundary lines; further, obtaining a ground plane in which the target vehicle is located, and determining an intersection point of the ground plane and the lower boundary line as a candidate road point corresponding to the lower boundary line; further, determining a target tangent formed by the photographing component and a vehicle head boundary point of the target vehicle (that is, a tangent to the vehicle head boundary point from the optical center of the photographing component), and determining an intersection point of the ground plane and the target tangent as a candidate road point corresponding to the target tangent; where the vehicle head boundary line is a point of tangency formed between the target tangent and the target vehicle; and further, determining, from a candidate road point corresponding to the lower boundary line and a candidate road point corresponding to the target tangent, a candidate road point relatively far from the target vehicle as the nearest road visible point corresponding to the target vehicle.

The location of the target vehicle is determined by using an ego-vehicle positioning point (that is, an actual vehicle location) of the target vehicle. For example, the ego-vehicle positioning point may be a front axle midpoint, a vehicle head midpoint, or a rear axle midpoint of the target vehicle. This embodiment of the present disclosure does not limit a specific location of the ego-vehicle positioning point of the target vehicle. For case of understanding, in this embodiment of the present disclosure, the rear axle midpoint of the target vehicle may be used as the ego-vehicle positioning point of the target vehicle. Certainly, the rear axle midpoint of the target vehicle may also be a center of mass of the target vehicle.

The ground plane on which the target vehicle is located may be the ground on which the target vehicle is located in the driving process, or may be the ground on which the target vehicle is located before driving. In other words, the nearest road visible point corresponding to the target vehicle may be determined in real time in the process of driving the target vehicle, or may be determined before driving the target vehicle (that is, in a case in which the vehicle is still, the nearest road visible point corresponding to the target vehicle is calculated in advance in the plane). In addition, the ground on which the target vehicle is located may be fitted into a straight line, and the ground on which the target vehicle is located may be referred to as a ground plane on which the target vehicle is located.

The component parameter of the photographing component includes a vertical visible angle and a component location parameter; the vertical visible angle refers to a photographing angle of the photographing component in a direction perpendicular to the ground plane, and the component location parameter refers to an installation location and an installation direction of the photographing component installed on the target vehicle; and the M photographing boundary lines further include an upper boundary line, and the upper boundary line is a boundary line that is in the M photographing boundary lines and that is farthest away from a road. A specific process of determining the M photographing boundary lines corresponding to the photographing component according to the component parameter of the photographing component may be described as follows: determining a primary optical axis of the photographing component according to the installation location and the installation direction in the component location parameter; further, evenly dividing the vertical visible angle to obtain an average vertical visible angle of the photographing component; and further, obtaining, along the primary optical axis, the lower boundary line and the upper boundary line that form the average vertical visible angle with the primary optical axis, where the primary optical axis, the upper boundary line, and the lower boundary line are located on a same plane, and the plane on which the primary optical axis, the upper boundary line, and the lower boundary line are located is perpendicular to the ground plane. An angle between the upper boundary line and the primary optical axis is equal to the average vertical visible angle, and an angle between the lower boundary line and the primary optical axis is equal to the average vertical visible angle.

A road image of the location at which the target vehicle is located may be photographed by using a monocular camera (that is, the photographing component may be a monocular camera). The photographing component may select different installation locations according to a form of the target vehicle, and the installation direction of the photographing component may be any direction (for example, the front of the vehicle). This embodiment of the present disclosure sets no limitation on the installation location and the installation direction of the photographing component. For example, the photographing component may be installed in the windshield of the target vehicle, a front outer edge of the roof, and the like. In some embodiments, the monocular camera may further be replaced with another device (for example, an automobile data recorder or a smartphone) that has an image collection function, with reduced hardware costs of collecting the road image of the location of the target vehicle.

The photographing component installed on the target vehicle may have a definition of a field of view parameter. For example, the field of view parameter may include a horizontal viewing angle α and a vertical viewing angle β, the horizontal viewing angle represents a visual angle (that is, a horizontal visual angle, same as a concept of a wide angle) of the photographing component in a horizontal direction, and the vertical viewing angle (that is, a vertical visible angle) represents a visual angle of the photographing component in a vertical direction. A visual range of the photographing component in the horizontal direction may be determined by using the horizontal viewing angle, and a visual range of the photographing component in the vertical direction may be determined by using the vertical viewing angle. Two photographing boundary lines formed by the vertical viewing angle may be an upper boundary line and a lower boundary line, and the upper boundary line and the lower boundary line are boundary lines corresponding to the visual range in the vertical direction.

FIG. 4 is a schematic diagram of a camera modeling scenario according to an embodiment of the present disclosure. As shown in FIG. 4, the photographing component may be represented as an optical system with an image plane 40a and a prism 40b. The prism 40b may include an optical center 40c. The optical center 40c may represent a center point of the prism 40b. A straight line that passes through the optical center 40c may be referred to as a primary optical axis 40d. Boundary lines that form an average vertical visible angle with the primary optical axis 40d may be an upper boundary line 41a (that is, an upper boundary 41a) and a lower boundary line 41b (that is, a lower boundary 41b), and the upper boundary line 41a and the lower boundary line 41b are boundary lines of the photographing component at the vertical viewing angle. In addition, based on the primary optical axis 40d shown in FIG. 4, (M−2) boundary lines may be further determined, for example, two boundary lines of the photographing component at the horizontal viewing angle. The M boundary lines corresponding to the photographing component are not listed one by one herein.

An included angle between the upper boundary line 41a visible to the photographing component and the primary optical axis 40d is an included angle 42a, an included angle between the lower boundary line 41b visible to the photographing component and the primary optical axis 40d is an included angle 42b, the included angle 42a is equal to the included angle 42b, the included angle 42a and the included angle 42b are both equal to β/2 (that is, the average vertical visible angle), and β indicates the vertical visible angle.

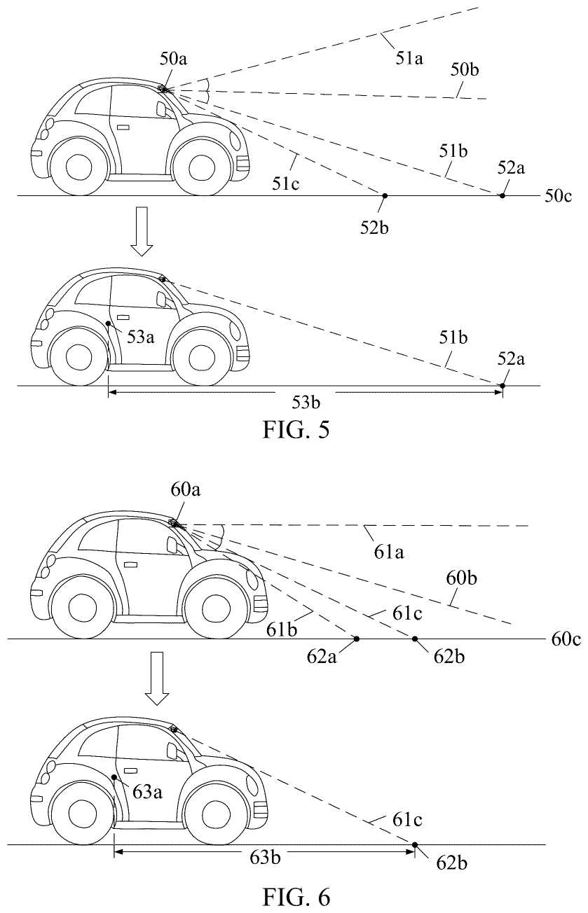

For installing the photographing component to the target vehicle, reference may be made to FIG. 5. FIG. 5 is a schematic diagram of a scenario in which a road visible point distance is determined according to an embodiment of the present disclosure. It is assumed that the photographing component is installed in the front windshield of the target vehicle in FIG. 5. As shown in FIG. 5, the primary optical axis of the photographing component may be the primary optical axis 50b, the upper boundary line of the photographing component may be the upper boundary line 51a (that is, the straight line 51a), the lower boundary line of the photographing component may be the lower boundary line 51b (that is, the straight line 51b), a target tangent formed by the photographing component and the vehicle head boundary point of the target vehicle may be a target tangent 51c (that is, a tangent 51c), the ground on which the target vehicle is located may be a ground plane 50c, and the center of light of the photographing component is the optical center 50a.

As shown in FIG. 5, the ground plane 50c and the straight line 51b may have an intersection point 52a (that is, a candidate road point 52a corresponding to the lower boundary line 51b) in front of the vehicle, and the ground plane 50c and the tangent 51c may have an intersection point 52b (that is, a candidate road point 52b corresponding to the target tangent 51c) in front of the vehicle. In this embodiment of the present disclosure, a point (that is, the candidate road point 52a) that is in the candidate road point 52a and the candidate road point 52b and that is farther from the ego-vehicle positioning point 53a (the ego-vehicle positioning point 53a is the rear axle center of the target vehicle as an example for description in this embodiment of the present disclosure) may be used as the nearest road visible point, that is, a distance from the candidate road point 52a to the ego-vehicle positioning point 53a is greater than a distance from the candidate road point 52b to the ego-vehicle positioning point 53a. In addition, in this embodiment of the present disclosure, a distance between the nearest road visible point 52a and the ego-vehicle positioning point 53a of the target vehicle may be determined as a road visible point distance 53b.

For installing the photographing component to the target vehicle, reference may be made to FIG. 6. FIG. 6 is a schematic diagram of a scenario in which a road visible point distance is determined according to an embodiment of the present disclosure. It is assumed that the photographing component is installed in a front windshield of the target vehicle in FIG. 6. As shown in FIG. 6, the primary optical axis of the photographing component may be the primary optical axis 60b, the upper boundary line of the photographing component may be the upper boundary line 61a (that is, the straight line 61a), the lower boundary line of the photographing component may be the lower boundary line 61b (that is, the straight line 61b), a target tangent formed by the photographing component and the vehicle head boundary point of the target vehicle may be a target tangent 61c (that is, a tangent 61c), the ground on which the target vehicle is located may be a ground plane 60c, and the center of light of the photographing component is the optical center 60a.

As shown in FIG. 6, the ground plane 60c and the straight line 61b may have an intersection point 62a (that is, a candidate road point 62a corresponding to the lower boundary line 61b) in front of the vehicle, and the ground plane 60c and the tangent 61c may have an intersection point 62b (that is, a candidate road point 62b corresponding to the target tangent 61c) in front of the vehicle. In this embodiment of the present disclosure, a point (that is, the candidate road point 62a) that is in the candidate road point 62a and the candidate road point 62b and that is farther from the ego-vehicle positioning point 63a (the ego-vehicle positioning point 63a is the rear axle center of the target vehicle as an example for description in this embodiment of the present disclosure) may be used as the nearest road visible point, that is, a distance from the candidate road point 62a to the ego-vehicle positioning point 63a is greater than a distance from the candidate road point 62b to the ego-vehicle positioning point 63a. In addition, in this embodiment of the present disclosure, a distance between the nearest road visible point 62a and the ego-vehicle positioning point 63a of the target vehicle may be determined as a road visible point distance 63b.

In operation S102, obtain, according to vehicle location status information of the target vehicle and the road visible region, local map data associated with the target vehicle.

A specific process of obtaining the local map data associated with the target vehicle may be described as follows: obtaining a vehicle location point of the target vehicle in the vehicle location status information of the target vehicle, and determining, according to the vehicle location point, a circular error probable corresponding to the target vehicle; determining a distance between the road visible region (for example, the nearest road visible point) and the target vehicle as a road visible point distance; determining, according to the vehicle location status information, the circular error probable, and the road visible point distance, a region upper limit corresponding to the target vehicle and a region lower limit corresponding to the target vehicle; and determining, from global map data, map data between a road location indicated by the region upper limit and a road location indicated by the region lower limit as the local map data associated with the target vehicle. The road location indicated by the region upper limit is located in front of the target vehicle in the driving direction, that is, in the driving direction, the road location indicated by the region upper limit is located in front of the target vehicle. In the driving direction, the road location indicated by the region upper limit is in front of the road location indicated by the region lower limit. In the driving direction, the road location indicated by the region lower limit is in front of or behind the target vehicle. The nearest road visible point is located in the local map data. The local map data may include at least one lane associated with the target vehicle. In this way, accurate local map data may be obtained with reference to the vehicle location status information of the target vehicle and the road visible region (that is, the road location observed by the vision of the target vehicle), thereby improving lane-level positioning accuracy.

The vehicle location status information includes a vehicle location point of the target vehicle and a vehicle driving state of the target vehicle at the vehicle location point, and a circular error probable corresponding to the target vehicle may be determined according to the vehicle location point of the target vehicle. The circular error probable corresponding to the target vehicle may be determined by using precision estimation (that is, precision measurement). Precision measurement is a process of calculating a difference between a positioning location (that is, the vehicle location point) and an actual location. The actual location actually exists, and the positioning location is obtained by using a positioning method or a positioning system.

A specific process of precision estimation is not limited in this embodiment of the present disclosure. For example, in this embodiment of the present disclosure, factors such as global navigation satellite system (GNSS) satellite quality, sensor noise, and visual confidence are considered to establish a mathematical model, for obtaining comprehensive error estimation. The comprehensive error estimation may be represented by a circular error probable (CEP). The circular error probable is a probability that the actual location will fall within a circle with a radius r and the target vehicle as the center. The circular error probable is the radius r of the circle. The circular error probable is represented by CEPX, and X is a number representing a probability. For example, the circular error probable may be represented as a form of the circular error probable such as CEP95 (i.e., X is equal to 95) or CEP99 (i.e., X is equal to 99). The error CEP95=r indicates that there is a 95% probability that the actual location is within a circle centered on the output location (i.e., the ego-vehicle positioning point) with r as the radius. The error CEP99=r indicates that there is a 99% probability that the actual location is within a circle centered on the output location (i.e., the ego-vehicle positioning point) with r as the radius. For example, CEP95 of the positioning accuracy is 5 m, which indicates that there is a 95% probability that the actual positioning point (i.e., the actual location) is within a circle centered on the given positioning point (i.e., the ego-vehicle positioning point) with a radius of 5 m.

The global navigation satellite system may include but is not limited to the Global Positioning System (GPS). The GPS is a high-precision radio navigation positioning system based on an artificial earth satellite. The GPS can provide an accurate geographic location and accurate time information anywhere globally and in the near-Earth space.

In this embodiment of the present disclosure, historical status information of the target vehicle in a historical positioning time period may be obtained, the ego-vehicle positioning point (that is, positioning point information) of the target vehicle is determined according to the historical status information, and the ego-vehicle positioning point is configured for indicating location coordinates (that is, longitude and latitude coordinates) of the target vehicle. The historical status information includes but is not limited to global positioning system information, such as precise point positioning (PPP) based on GNSS positioning, real-time kinematic (RTK) based on GNSS positioning, vehicle control information, vehicle visual perception information, and inertial measurement unit (IMU) information. Certainly, in this embodiment of the present disclosure, the latitude and longitude coordinates of the target vehicle may be directly determined by using the global positioning system.

The historical positioning time period may be a previous time period of a current moment, and a time length of the historical positioning time period is not limited in this embodiment of the present disclosure. The vehicle control information may indicate a control behavior of the target object against the target vehicle, and the vehicle visual perception information may indicate a lane line color, a lane line pattern type, and the like that are perceived by the target vehicle by using the photographing component. The global positioning system information indicates a longitude and a latitude of the target vehicle. The inertial measurement unit information indicates an apparatus that mainly includes an accelerometer and a gyroscope, and is configured to measure an object triaxial attitude angle (or an angular rate) and an acceleration.

A specific process of determining the region upper limit corresponding to the target vehicle and the region lower limit corresponding to the target vehicle according to the vehicle location status information, the circular error probable, and the road visible point distance may be described as follows: performing first operation processing on the circular error probable and the road visible point distance to obtain the region lower limit corresponding to the target vehicle. For example, the first operation processing may be a subtraction operation, the road visible point distance may be a subtrahend, and the circular error probable may be a minuend. In addition, the road visible point distance may be extended along the driving direction by using the vehicle driving state to obtain an extended visible point distance, and second operation processing is performed on the extended visible point distance and the circular error probable to obtain the region upper limit corresponding to the target vehicle. The extended visible point distance is greater than the road visible point distance. For example, the second operation processing may be an addition operation.

In other words, in this embodiment of the present disclosure, the ego-vehicle positioning point (that is, the vehicle location point) may be used as a center, and map data (for example, lane-level data) from the rear L-r (that is, the region lower limit) of the target vehicle to the front r+D (that is, the region upper limit) of the target vehicle is obtained, where r is a vehicle positioning error (that is, the circular error probable), D represents the extended visible point distance, and L represents the road visible point distance. r may be a positive number, L may be a positive number, and D may be a positive number greater than L. In this embodiment of the present disclosure, units configured for r, L, and D are not limited. For example, a unit configured for r may be meter, kilometer, or the like, a unit configured for L may be meter, kilometer, or the like, and a unit configured for D may be meter, kilometer, or the like.

The vehicle driving state may include but is not limited to a driving speed of the target vehicle and a driving heading angle of the target vehicle. The driving speed may be configured for determining the extended visible point distance. A larger driving speed indicates a larger extended visible point distance. In other words, the driving speed may be configured for determining a degree of extending the road visible point distance, and a larger driving speed indicates a larger extension degree. For example, when the driving speed is relatively low, D=L+25. For another example, when the driving speed is relatively high, D=L+30.

Therefore, in this embodiment of the present disclosure, an objective impact of the vehicle positioning precision (that is, the circular error probable) and the first visible point (that is, the nearest road visible point) may be effectively considered in an algorithm (that is, with reference to positioning precision estimation and the first visible point), a corresponding longitudinal range of a visual identification result given by the photographing component is determined, with enhanced adaptability of the algorithm, thereby ensuring accurate lane-level positioning in the following operation S103.

The vehicle location status information includes the vehicle driving state of the target vehicle. The specific process of obtaining the local map data associated with the target vehicle may further be described as follows: determining a distance between the road visible region (for example, the nearest road visible point) and the target vehicle as a road visible point distance, and determining the road visible point distance as a region lower limit corresponding to the target vehicle. In addition, the road visible point distance may be extended along the driving direction by using the vehicle driving state to obtain the extended visible point distance, and the extended visible point distance is determined as the region upper limit corresponding to the target vehicle. In the global map data, map data between the road location indicated by the region upper limit and the road location indicated by the region lower limit is determined as the local map data associated with the target vehicle. The road location indicated by the region upper limit is located in front of the target vehicle in the driving direction, that is, in the driving direction, the road location indicated by the region upper limit is located in front of the target vehicle. In the driving direction, the road location indicated by the region upper limit is in front of the road location indicated by the region lower limit. In the driving direction, the road location indicated by the region lower limit is in front of or behind the target vehicle. The nearest road visible point is located in the local map data. The local map data may include at least one lane associated with the target vehicle.

In other words, in this embodiment of the present disclosure, the ego-vehicle positioning point (that is, the vehicle location point) may be used as a center, and map data (for example, lane-level data) from the rear L (that is, the region lower limit) of the target vehicle to the front D (that is, the region upper limit) of the target vehicle may be obtained. D represents the extended visible point distance, and L represents the road visible point distance. L may be a positive number, and D may be a positive number greater than L.

Therefore, in this embodiment of the present disclosure, an objective impact of the first visible point (that is, the nearest road visible point) may be effectively considered in an algorithm, a corresponding longitudinal range of a visual identification result given by the photographing component is determined, thereby enhancing adaptability of the algorithm, and ensuring accurate lane-level positioning in the following operation S103.

A specific process of determining, from the global map data, the map data between the road location indicated by the region upper limit and the road location indicated by the region lower limit as the local map data associated with the target vehicle may be described as follows: determining, from the global map data, a map location point corresponding to the vehicle location status information; determining, from the global map data according to the map location point and the region lower limit, a road location indicated by the region lower limit; where if the region lower limit is a positive number, the road location indicated by the region lower limit is in front of the map location point in the driving direction; and if the region lower limit is a negative number, the road location indicated by the region lower limit is located behind the map location point in the driving direction; determining, from the global map data according to the map location point and the region upper limit, a road location indicated by the region upper limit; and finally determining map data between the road location indicated by the region lower limit and a road location indicated by the region upper limit as the local map data associated with the target vehicle; The local map data belongs to the global map data.

The driving heading angle may be configured for determining the local map data. For example, when a quantity of map data between the road location indicated by the region upper limit and the road location indicated by the region lower limit is at least two (that is, a fork road), in this embodiment of the present disclosure, the local map data associated with the target vehicle may be determined, by using the driving heading angle, in the at least two pieces of map data. For example, when the driving heading angle is the west and the quantity of map data is two, map data that is in the two pieces of map data and that is oriented to the west is used as the local map data, for example, the left map data in the two pieces of map data that is seen in the driving process is used as the local map data.

In operation S103, determine, from the at least one lane of the local map data, a target lane to which the target vehicle belongs.

In this embodiment of the present disclosure, lane line observation information corresponding to a lane line photographed by the photographing component may be obtained, the lane line observation information, the vehicle location status information, and the local map data are matched to obtain a lane probability respectively corresponding to at least one lane in the local map data, and a lane corresponding to a maximum lane probability is determined as the target lane to which the target vehicle belongs.

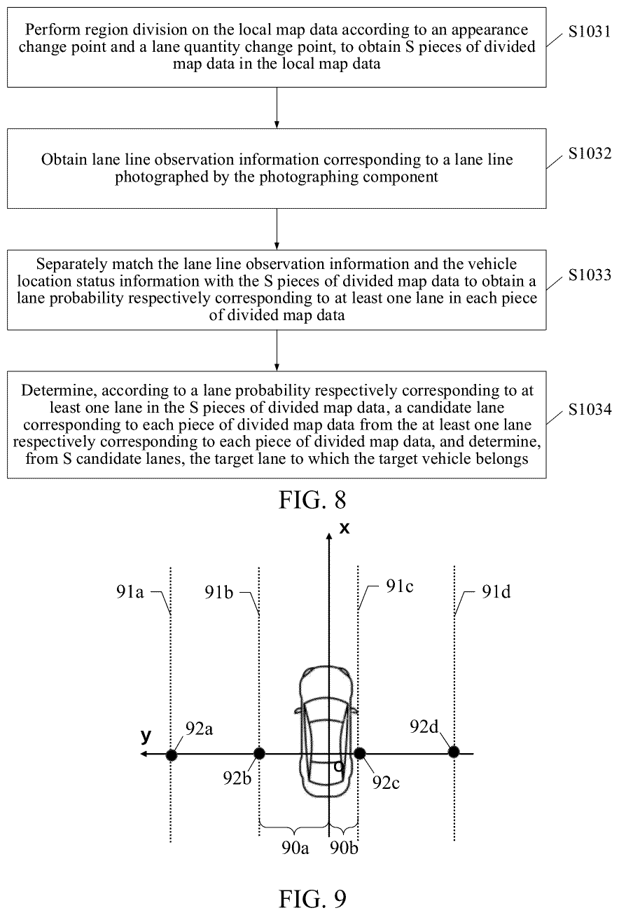

For example, in this embodiment of the present disclosure, region division may also be performed on the local map data, and the target lane to which the target vehicle belongs is determined according to divided map data obtained by means of region division, the lane line observation information, and the vehicle location status information. For a specific process of determining the target lane to which the target vehicle belongs according to the divided map data, the lane line observation information, and the vehicle location status information, refer to the following description of operation S1031 to operation S1034 in the corresponding embodiment shown in FIG. 8.

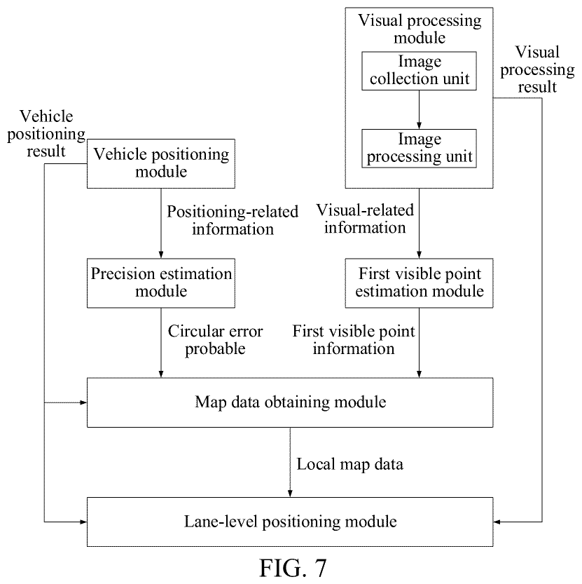

FIG. 7 is a schematic flowchart of lane-level positioning according to an embodiment of the present disclosure. The lane-level positioning procedure shown in FIG. 7 may include but is not limited to six modules: a vehicle positioning module, a visual processing module, a precision estimation module, a first visible point estimation module, a map data obtaining module, and a lane-level positioning module.

As shown in FIG. 7, the vehicle positioning module may be configured to obtain positioning-related information (that is, the vehicle location point) and a vehicle positioning result (that is, the vehicle driving state). The positioning-related information and the vehicle positioning result may be collectively referred to as positioning point information (that is, the vehicle location status information). The positioning point information of the vehicle positioning module may be configured for obtaining the local map data from the map data obtaining module, and performing lane matching in the lane-level positioning module.

As shown in FIG. 7, the visual processing module is configured to provide visual related information (that is, the component parameter) and a visual processing result (that is, the lane line observation information), and the visual processing module may include an image collection unit and an image processing unit. The image collection unit may represent the photographing component installed on the target vehicle. The image processing unit analyzes and processes a road image collected by the image collection unit, and outputs a lane line pattern type, a lane line color, a lane line equation, a color confidence, a pattern type confidence, and the like that are of an identified lane line around (for example, on the left or right of) the target vehicle.

As shown in FIG. 7, the precision estimation module may obtain the positioning-related information outputted by the vehicle positioning module, and estimate positioning accuracy by using the vehicle positioning information (that is, the positioning-related information), where the positioning accuracy may be represented by a circular error probable. The first visible point estimation module may obtain visual related information outputted by the visual processing module, and may obtain a first visible point location (that is, the first visible point information) of the target vehicle by using installation information of the photographing component (that is, a camera extrinsic parameter, for example, the installation location and the installation direction), a camera intrinsic parameter (for example, the vertical visible angle), and three-dimensional geometric information of the target vehicle.

In some other embodiments, as shown in FIG. 7, the map data obtaining module may match, in the global map data, the road location corresponding to the target vehicle according to the circular error probable outputted by the precision estimation module, the positioning-related information outputted by the vehicle positioning module, the vehicle positioning result outputted by the vehicle positioning module, and the first visible point information outputted by the first visible point estimation module, for obtaining local map information of a current location. In addition, the lane-level positioning module may implement, in the local map data, lane-level positioning of the target vehicle according to the vehicle positioning result outputted by the vehicle positioning module and the visual processing result outputted by the visual processing module, that is, determine, in the local map data, the target lane to which the target vehicle belongs (that is, determine a lane-level positioning location of the target vehicle).

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

As such, the embodiments of the present disclosure provide a meticulous lane-level positioning method. In this method, accurate local map data can be obtained by comprehensively considering the nearest road visible point corresponding to the target vehicle and the vehicle location status information of the target vehicle. Because the road location closest to the target vehicle is observed by the vision of the target vehicle, the local map data matches the map data seen by the vision of the target vehicle. When the target lane to which the target vehicle belongs is determined in the local map data that matches the vision, the target lane to which the target vehicle belongs can be accurately located, thereby improving accuracy of locating the target lane to which the target vehicle belongs, that is, improving accuracy of lane-level positioning.

In some embodiments, referring to FIG. 8, FIG. 8 is a schematic flowchart of a lane positioning method according to an embodiment of the present disclosure. The lane positioning method may include the following operation S1031 to operation S1034, and operation S1031 to operation S1034 are a specific embodiment of operation S103 in the embodiment corresponding to FIG. 3.

In operation S1031, perform region division on the local map data according to an appearance change point and a lane quantity change point, to obtain S pieces of divided map data in the local map data.

S herein may be a positive integer; a quantity of map lane lines in a same divided map data is fixed, and a map lane line pattern type and a map lane line color on a same lane line in same divided map data are fixed; and the appearance change point (that is, a line type/color change point) refers to a location at which the map lane line pattern type or the map lane line color on the same lane line in the local map data changes, and the lane quantity change point refers to a location at which the map lane line color in the local map data changes.

In other words, in this embodiment of the present disclosure, the local map data may be cut and interrupted in the longitudinal direction to form a lane-level data set (that is, a divided map data set). The lane-level data set may include at least one piece of lane-level data (that is, divided map data).

In operation S1032, obtain lane line observation information corresponding to a lane line photographed by the photographing component.

Specifically, a road image that is photographed by the photographing component and that corresponds to a road in the driving direction may be obtained. Then, element segmentation is performed on the road image to obtain a lane line in the road image. Then, attribute identification may be performed on the lane line to obtain the lane line observation information (that is, lane line attribute information) corresponding to the lane line. The lane line observation information is data information configured for describing a lane line attribute, and the lane line observation information may include but is not limited to a lane line color, a lane line pattern type (that is, a lane line type), and a lane line equation. In this embodiment of the present disclosure, lane line observation information corresponding to each lane line in the road image may be identified. Certainly, in this embodiment of the present disclosure, lane line observation information corresponding to at least one lane line in the road image may alternatively be identified, for example, lane line observation information corresponding to a left lane line and lane line observation information corresponding to the right lane line of the target vehicle in the road image.

The element segmentation may first segment a background and a road in the road image, and then segment the road in the road image to obtain a lane line in the road, where a quantity of lane lines identified by the photographing component is determined by a horizontal viewing angle of the photographing component, a larger horizontal viewing angle indicates a larger quantity of lane lines photographed, and a smaller horizontal viewing angle indicates a smaller quantity of lane lines photographed. A specific algorithm configured for element segmentation is not limited in this embodiment of the present disclosure. For example, the element segmentation algorithm may be a pixel-by-pixel binary classification method, or may be a robust multi-Lane detection with affinity fields (LancAF) algorithm.

The lane line color may include but is not limited to yellow, white, blue, green, gray, and black. The lane line pattern type includes but is not limited to a single solid line, a single dashed line, double solid lines, double dashed lines, a left dashed line and a right solid line, a left solid line and a right dashed line, a guard bar, a kerb stone, a curb, and a roadside edge. One lane line may include at least one curve. For example, a left dashed line and a right solid line may include one solid line and one dashed line, and a total of two curves. In this case, a left dashed line and a right solid line may be represented by using one lane line equation, that is, one lane line equation may be configured for representing one lane line, and one lane line equation may be configured for representing at least one curve. For case of understanding, in this embodiment of the present disclosure, that a kerb stone, a curb, and a roadside edge are all lane lines is used as examples for description. The kerb stone, the curb, and the roadside edge may alternatively be not considered as lane lines.

An expression form of the lane line equation is not limited in this embodiment of the present disclosure. For example, the expression form of the lane line equation may be a cubic polynomial: y=d+a*x+b*x²+c*x³ For another example, the expression form of the lane line equation may be a quadratic polynomial: y=d+a*x+b*x² For another example, the expression form of the lane line equation may be a quartic polynomial: y=d+a*x+b*x²+c*x³+e*x⁴. a, b, c, d and e are fitting coefficients of the polynomial.

When the lane line observation information includes the lane line color corresponding to the lane line and the lane line pattern type corresponding to the lane line, a specific process of performing attribute identification on the lane line may be described as follows: inputting the lane line to an attribute identification model, and performing feature extraction on the lane line by using the attribute identification model to obtain a color attribute feature corresponding to the lane line and a pattern type attribute feature corresponding to the lane line; and determining the lane line color according to the color attribute feature corresponding to the lane line, and determining the lane line pattern type according to the pattern type attribute feature corresponding to the lane line. The lane line color is configured for matching with a map lane line color in the local map data, and the lane line pattern type is configured for matching with a map lane line pattern type in the local map data.

The attribute identification module may perform normalization processing on the color attribute feature to obtain a normalized color attribute vector, where the normalized color attribute vector may indicate a color probability that the lane line color of the lane line is the foregoing color (that is, the color confidence), and a color corresponding to a maximum color probability is the lane line color of the lane line. Similarly, the attribute identification module may perform normalization processing on the pattern type attribute feature to obtain a normalized pattern type attribute vector, where the normalized pattern type attribute vector may indicate a pattern type probability that the lane line pattern type of the lane line is the foregoing pattern type (that is, the pattern type confidence), and a pattern type corresponding to a maximum pattern type probability is the lane line pattern type of the lane line.

The attribute identification model may be a multi-output classification model, and the attribute identification module may simultaneously execute two independent classification tasks. In this embodiment of the present disclosure, a model type of the attribute identification model is not limited. In addition, in this embodiment of the present disclosure, the lane line may be separately entered into a color identification model and a pattern type identification model. The color attribute feature corresponding to the lane line is outputted by using the color identification model, and the lane line color is further determined according to the color attribute feature corresponding to the lane line. The pattern type attribute feature corresponding to the lane line is outputted by using the pattern type identification model, and the lane line pattern type is further determined according to the pattern type attribute feature corresponding to the lane line.

FIG. 9 is a schematic diagram of a scenario in which a lane line is identified according to an embodiment of the present disclosure. FIG. 9 is described by using an example in which the quantity of lane lines identified by the photographing component is 4. For example, the four lane lines in the road image may be two lane lines on the left of the target vehicle and two lane lines on the right of the target vehicle. In some embodiments, in this embodiment of the present disclosure, an indistinct lane line in the road image may be removed, and a clear lane line in the road image may be reserved. In this case, the four lane lines shown in FIG. 9 may be clear lane lines in the road image.

As shown in FIG. 9, the two lane lines on the left of the target vehicle may be a lane line 91a and a lane line 91b, the two lane lines on the right of the target vehicle may be a lane line 91c and a lane line 91d, a distance from the ego-vehicle positioning point of the target vehicle to the lane lines on both sides of the vehicle may be lane line intercepts, and the lane line intercepts may indicate the locations of the target vehicle in the lanes by using a horizontal distance. For example, the lane line intercept between the target vehicle and the lane line 91b may be a lane intercept 90a, and the lane intercept between the target vehicle and the lane line 91c may be a lane intercept 90b.

For example, as shown in FIG. 9, if the target vehicle is on a road edge (that is, the target vehicle is driving on the leftmost lane), a lane line pattern type of the lane line 91a may be a road edge, a kerb stone, or a curb, the lane line 91b represents a left lane line of the leftmost lane, and no lane exists between the lane line 91a and the lane line 91b. For example, the lane line pattern type of the lane line 91b may be a single solid line.

A quantity of the lane lines is at least two. When the lane line observation information includes a lane line equation, a specific process of performing attribute identification on the lane line may be further described as follows: performing a reverse perspective change on the at least two lane lines (adjacent lane lines) to obtain changed lane lines respectively corresponding to the at least two lane lines; where the reverse perspective change may convert the lane line in the road image from an image icon to world coordinates (for example, coordinates in a vehicle coordinate system of the embodiment corresponding to FIG. 9); and then separately performing fitting reconstruction on the at least two changed lane lines to obtain the lane line equation respectively corresponding to each changed lane line. The lane line equation is configured for matching with shape point coordinates in the local map data, and the shape point coordinates in the local map data are configured for fitting a road shape of at least one lane in the local map data.

The lane line equation is determined based on a vehicle coordinate system (VCS). The vehicle coordinate system is a special three-dimensional moving coordinate system Oxyz configured for describing vehicle motion. Because the lane line is on the ground, the lane line equation is correspondingly based on Oxy in the vehicle coordinate system. A coordinate system origin O of the vehicle coordinate system is fixed relative to the vehicle location, and the coordinate system origin O may be the ego-vehicle positioning point of the vehicle. A specific location of the coordinate system origin of the vehicle coordinate system is not limited in this embodiment of the present disclosure. Similarly, an establishment manner of the vehicle coordinate system is not limited in this embodiment of the present disclosure. For example, the vehicle coordinate system may be established as a left-hand system. When the vehicle is in a static state on a horizontal road surface, an x-axis of the vehicle coordinate system is parallel to the ground and points to the front of the vehicle, a y-axis of the vehicle coordinate system is parallel to the ground and points to the left of the vehicle, and a z-axis of the vehicle coordinate system is perpendicular to the ground and points to the top of the vehicle. For another example, the vehicle coordinate system may be established as a right-hand system. When the vehicle is in a static state on a horizontal road surface, an x-axis of the vehicle coordinate system is parallel to the ground and points to the front of the vehicle, a y-axis of the vehicle coordinate system is parallel to the ground and points to the right of the vehicle, and a z-axis of the vehicle coordinate system is perpendicular to the ground and points to the top of the vehicle.

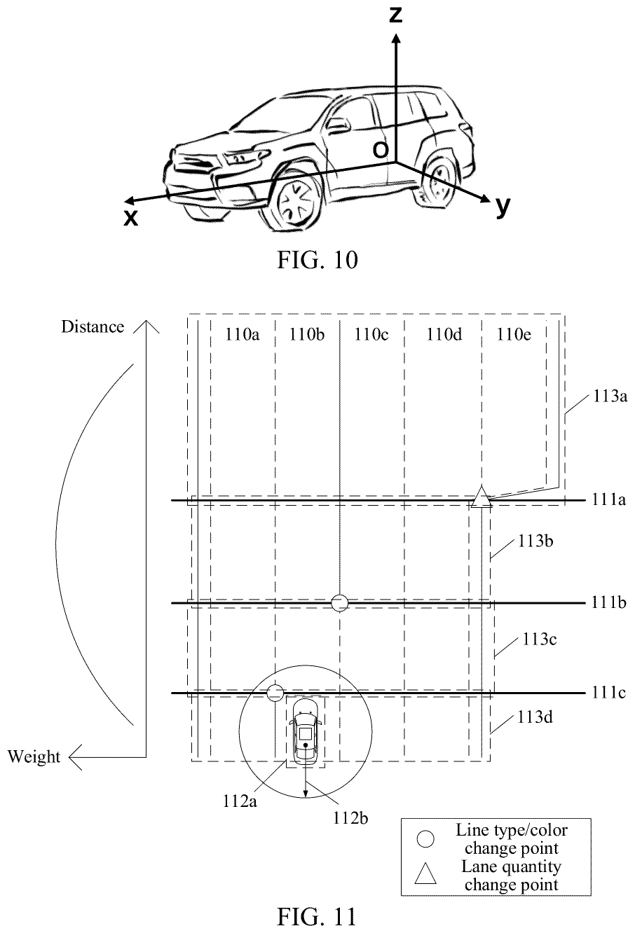

FIG. 10 is a schematic diagram of a vehicle coordinate system according to an embodiment of the present disclosure. FIG. 10 is a schematic diagram of a vehicle coordinate system of a left-hand system. An origin of the coordinate system may be a rear axis midpoint of a target vehicle. The vehicle coordinate system may include an x-axis, a y-axis, and a z-axis. A positive direction of the x-axis points to the front of the vehicle from the origin of the coordinate system, a positive direction of the y-axis points to the left side of the vehicle from the origin of the coordinate system, and a positive direction of the z-axis points to the top of the vehicle from the origin of the coordinate system. Similarly, a negative direction of the x-axis points to the rear of the vehicle from the origin of the coordinate system, a negative direction of the y-axis points to the right side of the vehicle from the origin of the coordinate system, and a negative direction of the z-axis points to the underside of the vehicle from the origin of the coordinate system.

Referring to FIG. 9, a vehicle coordinate system of a left-hand system is shown in FIG. 9. An x-axis is parallel to the ground and points to the front of the vehicle, and a y-axis is parallel to the ground and points to the left side of the vehicle. Lane line equations corresponding to the lane line 91a, the lane line 91b, the lane line 91c, and the lane line 91d may be configured for determining lane line intercepts corresponding to the lane line 91a, the lane line 91b, the lane line 91c, and the lane line 91d. For example, the coordinate x=0 corresponding to the x-axis in the vehicle coordinate system is substituted into the lane line equation corresponding to the lane line 91b, and the lane line intercept 90a of the lane line 91b may be obtained. For another example, the coordinate x=0 corresponding to the x-axis in the vehicle coordinate system is substituted into the lane line equation corresponding to the lane line 91c, and the lane line intercept 90b of the lane line 91c may be obtained.

In operation S1033, separately match the lane line observation information and the vehicle location status information with the S pieces of divided map data to obtain a lane probability respectively corresponding to at least one lane in each piece of divided map data.

The local map data may include a total quantity of lanes, a map lane line color, a map lane line pattern type, shape point coordinates, a lane speed limit, a lane heading angle, and the like. Correspondingly, the divided map data may include the total quantity of lanes, the map lane line color, the map lane line pattern type, the shape point coordinates, the lane speed limit, the lane heading angle, and the like.

The S pieces of divided map data include divided map data Lᵢ, and i herein may be a positive integer less than or equal to S. In this embodiment of the present disclosure, the lane line observation information, the vehicle location status information, and the divided map data Lᵢ may undergo matching to obtain a lane probability respectively corresponding to at least one lane in the divided map data Lᵢ.

The lane line observation information may include a lane line color, a lane line pattern type, and a lane line equation, and the vehicle location status information may include a driving speed and a driving heading angle. In this embodiment of the present disclosure, when the lane line observation information, the vehicle location status information, and the divided map data Lᵢ undergo matching, the lane line color may be matched with a map lane line color (that is, a lane line color stored in the map data), the lane line pattern type is matched with a map lane line pattern type (that is, a lane line pattern type stored in the map data), the lane line equation is matched with shape point coordinates, the driving speed is matched with a lane speed limit, and the driving heading angle is matched with a lane heading angle. Different matching factors may correspond to different matching weights. For example, a matching weight between the lane line color and the map lane line color may be 0.2, and a matching weight between the driving speed and the lane speed limit may be 0.1. In this way, for different types of lane line observation information, more accurate matching results may be obtained by imparting different weights.

A first factor probability respectively corresponding to the at least one lane may be determined according to a matching result between the lane line color and the map lane line color. A second factor probability respectively corresponding to the at least one lane may be determined according to a matching result between the lane line pattern type and the map lane line pattern type. A third factor probability respectively corresponding to the at least one lane may be determined according to a matching result between the lane line equation and the shape point coordinates. A fourth factor probability respectively corresponding to the at least one lane may be determined according to a matching result between the driving speed and the lane speed limit. A fifth factor probability respectively corresponding to the at least one lane may be determined according to a matching result between the driving heading angle and the lane heading angle. Further, the first factor probability corresponding to each lane, the second factor probability corresponding to each lane, the third factor probability corresponding to each lane, the fourth factor probability corresponding to each lane, and the fifth factor probability corresponding to each lane may be weighted by using a matching weight corresponding to each matching factor, for determining a lane probability respectively corresponding to the at least one lane.

In some other embodiments, the embodiments of the present disclosure may further determine, by using at least one of the first factor probability, the second factor probability, the third factor probability, the fourth factor probability, or the fifth factor probability, the lane probability respectively corresponding to the at least one lane. A specific process of determining the lane probability respectively corresponding to the at least one lane is not limited in this embodiment of the present disclosure.

For example, this embodiment of the present disclosure may further obtain lane information (for example, a quantity of map lane lines) corresponding to the target vehicle. Then, target prior information matching the lane line observation information is determined. The target prior information is prior probability information for predicting a lane location under a condition of the lane line observation information. For example, the target prior information may include a type prior probability, a color prior probability, and a spacing prior probability that are respectively corresponding to one or more lane lines. Then, posterior probability information respectively corresponding to the at least one lane may be determined based on the lane information and the target prior information. The posterior probability information includes a posterior probability respectively corresponding to the target vehicle on the at least one lane. The posterior probability herein may also be referred to as a lane probability.

In operation S1034, determine, according to a lane probability respectively corresponding to at least one lane in the S pieces of divided map data, a candidate lane corresponding to each piece of divided map data from the at least one lane respectively corresponding to each piece of divided map data, and determine, from S candidate lanes, the target lane to which the target vehicle belongs.

For example, a maximum lane probability in the lane probability respectively corresponding to the at least one lane in the divided map data Lᵢ may be determined as a candidate probability (that is, an optimal probability) corresponding to the divided map data Lᵢ, and a lane with the maximum lane probability in the at least one lane in the divided map data Lᵢ is determined as a candidate lane (that is, an optimal lane) corresponding to the divided map data Lᵢ. After the candidate probability respectively corresponding to the S pieces of divided map data and the candidate lane respectively corresponding to the S pieces of divided map data are determined, a longitudinal average distance between the target vehicle and each of the S pieces of divided map data is obtained, and region weights respectively corresponding to the S pieces of divided map data are determined according to a nearest road visible point and S longitudinal average distances. The region weights respectively corresponding to the S pieces of divided map data may be determined according to the road visible point distance and the S longitudinal average distances. Then, a candidate probability may be multiplied by a region weight that belongs to same divided map data to obtain S trusted weights respectively corresponding to the divided map data. Finally, a candidate lane corresponding to a maximum trusted weight of the S trusted weights may be determined as the target lane to which the target vehicle belongs.

Because the S pieces of divided map data may be respectively matched with the lane line observation information and the vehicle location status information, the S pieces of divided map data may be corresponding to the same candidate lane, for example, the divided map data L₁ and the divided map data L₂ are both corresponding to the same candidate lane.

The region weight is a real number greater than or equal to 0, the region weight is a real number less than or equal to 1, and the region weight represents a confidence weight of divided map data configured for visual lane-level matching. A specific value of the region weight is not limited in this embodiment of the present disclosure. A region weight corresponding to divided map data of an intermediate region is greater, a region weight corresponding to divided map data of an edge region is smaller, and a location with a maximum region weight is a region most likely to be seen by the photographing component. For example, in this embodiment of the present disclosure, a segment of region in front of the first visible point (for example, L+10 location in front of the first visible point) may be used as a location with a maximum probability, and weights of two sides thereof are attenuated with the distance. In this case, for a specific process of determining the region weight according to the road visible point distance and the longitudinal average distance, refer to formula (1).

$$w ( x ) = {e}^{- λ * \vert x - ( L + h ) \vert} \qquad ( 1 )$$

where x represents the longitudinal average distance, and a control parameter λ is a normal number, and w(x) represents a region weight corresponding to divided map data whose longitudinal average distance is x. The larger the control parameter λ, the smaller the degree of difference between the S trusted weights, and the smaller the control parameter λ, the greater the degree of difference between the S trusted weights. The maximum probability distance h may represent a distance to h in front of the nearest road visible point, for example, h may be equal to 10. |x−(L+h)| represents obtaining the absolute value of x−(L+h).

For a specific process of determining the target lane in the S candidate lanes, refer to formula (2):

$$j = {arg max}_{i = 1 , … , S} \{ {P}_{i} * {w}_{i} \} \qquad ( 2 )$$

where i may be a positive integer less than or equal to S, Pᵢ may represent the candidate probability corresponding to the divided map data Lᵢ, wᵢ may represent the region weight corresponding to the divided map data Lᵢ, and Pᵢ*wᵢ may represent the trusted weight corresponding to the divided map data Lᵢ. argmax may express a subnet of a definition domain (i=1, . . . , S), any element in the subset may enable Pᵢ*wᵢ to have a maximum value, and j may represent a maximum value of Pᵢ*wᵢ (that is, a maximum trusted weight).

The divided map data Lᵢ includes a region upper boundary and a region lower boundary. In the driving direction, a road location indicated by the region upper boundary is in front of a road location indicated by the region lower boundary. A specific process of determining the longitudinal average distance between the target vehicle and the divided map data Lᵢ may be described as follows: determining an upper boundary distance between the target vehicle and the road location indicated by the region upper boundary of the divided map data Lᵢ (that is, the distance between the road location indicated by the region upper boundary and the ego-vehicle positioning point of the target vehicle), and determining a lower boundary distance between the target vehicle and the road location indicated by the region lower boundary of the divided map data Lᵢ (that is, the distance between the road location indicated by the region lower boundary and the ego-vehicle positioning point of the target vehicle). If the region upper boundary is in front of the ego-vehicle positioning point of the target vehicle, the upper boundary distance is a positive number; or if the region upper boundary is behind the ego-vehicle positioning point of the target vehicle, the upper boundary distance is a negative number. Similarly, if the region lower boundary is in front of the ego-vehicle positioning point of the target vehicle, the lower boundary distance is a positive number; or if the region lower boundary is behind the ego-vehicle positioning point of the target vehicle, the lower boundary distance is a negative number. Then, the average value of the upper boundary distance corresponding to the divided map data Lᵢ and the lower boundary distance corresponding to the divided map data Lᵢ may be determined as the longitudinal average distance between the target vehicle and the divided map data Lᵢ. Similarly, the longitudinal average distance between the target vehicle and the S pieces of divided map data may be determined.

FIG. 11 is a schematic diagram of a scenario in which region division is performed according to an embodiment of the present disclosure. FIG. 11 may be local map data corresponding to a target vehicle 112a. A radius of a circle shown in FIG. 11 may be a circular error probable 112b corresponding to the target vehicle 112a. Region division may be performed on the local map data by using a region division line to obtain S pieces of divided map data in the local map data. For case of understanding, in this embodiment of the present disclosure, S is equal to 4. Divided map data 113a may be obtained through division by using a region division line 111a, divided map data 113b may be obtained through division by using the region division line 111a and a region division line 111b, divided map data 113c may be obtained through division by using the region division line 111b and a region division line 111c, and divided map data 113d may be obtained through division by using the region division line 111c.

As shown in FIG. 11, a triangle may represent a lane quantity change point, a circle may represent a line type/color change point, the region division line 111a is determined according to the lane quantity change point, the region division line 111b is determined according to the line type/color change point, and the region division line 111c is determined according to the line type/color change point. The region division line 111a indicates that a quantity of lanes changes from 4 to 5, the region division line 111b indicates that the lane line pattern type changes from a dashed line to a solid line, and the region division line 111c indicates that the lane line pattern type changes from a solid line to a dashed line.

A region weight corresponding to the divided map data 113b is the largest, a region weight corresponding to the divided map data 113d is the smallest, a region weight corresponding to the divided map data 113a and a region weight corresponding to the divided map data 113c are between the region weight corresponding to the divided map data 113b and the region weight corresponding to the divided map data 113d. The distance shown in FIG. 11 may be a longitudinal average distance, and the weight may be a region weight. A relationship between the distance and the weight is configured for representing a size relationship of the region weight, not configured for representing a specific value of the region weight. In other words, the region weight is a discrete value, not a consecutive value shown in FIG. 11.

As shown in FIG. 11, the local map data may include five lanes and six lane lines. The five lanes may specifically include a lane 110a, a lane 110b, a lane 110c, a lane 110d, and a lane 110c. The six lane lines may specifically include a lane line 110a, a lane line 110b, a lane line 110c, a lane line 110d, and a lane line 110e. The divided map data 113a may include the lane 110a, the lane 110b, the lane 110c, the lane 110d, and the lane 110e. The divided map data 113b may include the lane 110a, the lane 110b, the lane 110c, and the lane 110d. The divided map data 113c may include the lane 110a, the lane 110b, the lane 110c, and the lane 110d. The divided map data 113d may include the lane 110a, the lane 110b, the lane 110c, and the lane 110d.

It can be learned that, in this embodiment of the present disclosure, after the local map data is obtained, region division may be performed on the local map data to obtain a lane-level data set (that is, a divided map data set) in the range (that is, the local map data), and a region weight is assigned to each piece of lane-level data in the lane-level data set according to the distance, so that a lane-level positioning algorithm is separately performed on each piece of lane-level data to find an optimal lane-level positioning result (that is, a candidate lane) corresponding to each piece of lane-level data. By determining the candidate lane respectively corresponding to each piece of divided map data, accuracy of determining the candidate lane in each piece of divided map data can be improved, and therefore, accuracy of determining the target lane to which the target vehicle belongs in the candidate lane is improved.

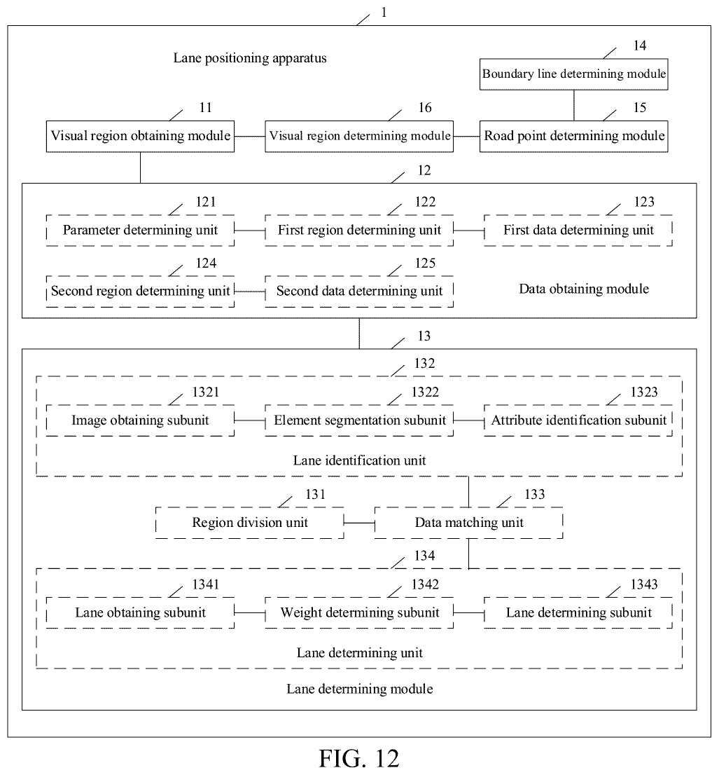

FIG. 12 is a schematic structural diagram of a lane positioning apparatus according to an embodiment of the present disclosure. The lane positioning apparatus I may include: a visual region obtaining module 11, a data obtaining module 12, and a lane determining module 13. In addition, the lane positioning apparatus 1 may further include: a boundary line determining module 14, a road point determining module 15, and a visual region determining module 16.

The visual region obtaining module 11 is configured to obtain a road visible region corresponding to a target vehicle, the road visible region being related to the target vehicle and a component parameter of a photographing component installed on the target vehicle, and being a road location photographed by the photographing component; and

the data obtaining module 12 is configured to obtain, according to vehicle location status information of the target vehicle and the road visible region, local map data associated with the target vehicle, the road visible region being located in the local map data; the local map data including at least one lane associated with the target vehicle.

The data obtaining module 12 includes: a parameter determining unit 121, a first region determining unit 122, and a first data determining unit 123.

The parameter determining unit 121 is configured to: obtain a vehicle location point of the target vehicle in the vehicle location status information of the target vehicle, and determine, according to the vehicle location point, a circular error probable corresponding to the target vehicle;
the parameter determining unit 121 is configured to determine a distance between the road visible region and the target vehicle as a road visible point distance;
the first region determining unit 122 is configured to determine, according to the vehicle location status information, the circular error probable, and the road visible point distance, a region upper limit corresponding to the target vehicle and a region lower limit corresponding to the target vehicle;
the vehicle location status information further includes a vehicle driving state of the target vehicle at the vehicle location point; and
the first region determining unit 122 is further configured to perform first operation processing on the circular error probable and the road visible point distance to obtain the region lower limit corresponding to the target vehicle.

The first region determining unit 122 is further configured to extend, by using the vehicle driving state, the road visible point distance along the driving direction to obtain an extended visible point distance, and perform second operation processing on the extended visible point distance and the circular error probable to obtain the region upper limit corresponding to the target vehicle.

The first data determining unit 123 is configured to determine, from global map data, map data between a road location indicated by the region upper limit and a road location indicated by the region lower limit as the local map data associated with the target vehicle; the road location indicated by the region upper limit being located in front of the target vehicle in a driving direction; and in the driving direction, the road location indicated by the region upper limit being in front of the road location indicated by the region lower limit.

The first data determining unit 123 is further configured to determine, from the global map data, a map location point corresponding to the vehicle location status information;
the first data determining unit 123 is further configured to determine, from the global map data according to the map location point and the region lower limit, a road location indicated by the region lower limit;
the first data determining unit 123 is further configured to determine, from the global map data according to the map location point and the region upper limit, a road location indicated by the region upper limit;
the first data determining unit 123 is further configured to determine map data between the road location indicated by the region lower limit and a road location indicated by the region upper limit as the local map data associated with the target vehicle; the local map data belonging to the global map data.

For specific implementations of the parameter determining unit 121, the first region determining unit 122, and the first data determining unit 123, refer to descriptions of operation S102 in the foregoing embodiment corresponding to FIG. 3. Details are not described herein again.

The vehicle location status information includes the vehicle driving state of the target vehicle.

The data obtaining module 12 includes: a second region determining unit 124 and a second data determining unit 125.

The second region determining unit 124 is configured to: determine a distance between the road visible region and the target vehicle as a road visible point distance, and determine the road visible point distance as a region lower limit corresponding to the target vehicle;
the second region determining unit 124 is configured to extend, by using the vehicle driving state, the road visible point distance along the driving direction to obtain an extended visible point distance, and determine the extended visible point distance as a region upper limit corresponding to the target vehicle; and
the second data determining unit 125 is configured to determine, from global map data, map data between a road location indicated by the region upper limit and a road location indicated by the region lower limit as the local map data associated with the target vehicle; the road location indicated by the region upper limit being located in front of the target vehicle in a driving direction; and in the driving direction, the road location indicated by the region upper limit being in front of the road location indicated by the region lower limit.

The second data determining unit 125 is further configured to determine, from the global map data, a map location point corresponding to the vehicle location status information;
the second data determining unit 125 is further configured to determine, from the global map data according to the map location point and the region lower limit, a road location indicated by the region lower limit;
the second data determining unit 125 is further configured to determine, from the global map data according to the map location point and the region upper limit, a road location indicated by the region upper limit; and
the second data determining unit 125 is further configured to determine map data between the road location indicated by the region lower limit and a road location indicated by the region upper limit as the local map data associated with the target vehicle; the local map data belonging to the global map data.

For specific implementations of the second region determining unit 124 and the second data determining unit 125, refer to the foregoing description of operation S102 in the embodiment corresponding to FIG. 3. Details are not described herein again.

The lane determining module 13 is configured to determine, from the at least one lane of the local map data, a target lane to which the target vehicle belongs.

The lane determining module 13 includes: a region division unit 131, a lane identification unit 132, a data matching unit 133, and a lane determining unit 134.

The region division unit 131 is configured to perform region division on the local map data according to an appearance change point and a lane quantity change point, to obtain S pieces of divided map data in the local map data. S is a positive integer; a quantity of map lane lines in a same divided map data is fixed, and a map lane line pattern type and a map lane line color on a same lane line in same divided map data are fixed; and the appearance change point refers to a location at which the map lane line pattern type or the map lane line color on the same lane line in the local map data changes, and the lane quantity change point refers to a location at which the map lane line color in the local map data changes.

The lane identification unit 132 is configured to obtain lane line observation information corresponding to a lane line photographed by the photographing component.

The lane identification unit 132 includes: an image obtaining subunit 1321, an element segmentation subunit 1322, and an attribute identification subunit 1323.

The image obtaining subunit 1321 is configured to obtain a road image that is photographed by the photographing component and that corresponds to a road in the driving direction;
the element segmentation subunit 1322 is configured to perform element segmentation on the road image to obtain a lane line in the road image; and
the attribute identification subunit 1323 is configured to perform attribute identification on the lane line to obtain the lane line observation information corresponding to the lane line.

The lane line observation information includes a lane line color corresponding to the lane line and a lane line pattern type corresponding to the lane line.

The attribute identification subunit 1323 is further configured to input the lane line to an attribute identification model, and perform feature extraction on the lane line by using the attribute identification model to obtain a color attribute feature corresponding to the lane line and a pattern type attribute feature corresponding to the lane line; and
the attribute identification subunit 1323 is further configured to: determine the lane line color according to the color attribute feature corresponding to the lane line, and determining the lane line pattern type according to the pattern type attribute feature corresponding to the lane line. The lane line color is configured for matching with a map lane line color in the local map data, and the lane line pattern type is configured for matching with a map lane line pattern type in the local map data.

A quantity of the lane lines is at least two. The lane line observation information includes a lane line equation.

The attribute identification subunit 1323 is further configured to perform a reverse perspective change on the at least two lane lines to obtain changed lane lines respectively corresponding to the at least two lane lines; and
the attribute identification subunit 1323 is further configured to separately perform fitting reconstruction on the at least two changed lane lines to obtain the lane line equation respectively corresponding to each changed lane line; the lane line equation being configured for matching with shape point coordinates in the local map data; and the shape point coordinates in the local map data being configured for fitting a road shape of at least one lane in the local map data.

For specific implementations of the image obtaining subunit 1321, the element segmentation subunit 1322, and the attribute identification subunit 1323, refer to descriptions of operation S1032 in the foregoing embodiment corresponding to FIG. 8. Details are not described herein again.

The data matching unit 133 is configured to separately match the lane line observation information and the vehicle location status information with the S pieces of divided map data to obtain a lane probability respectively corresponding to at least one lane in each piece of divided map data; and
the lane determining unit 134 is configured to: determine, according to a lane probability respectively corresponding to at least one lane in the S pieces of divided map data, a candidate lane corresponding to each piece of divided map data from the at least one lane respectively corresponding to each piece of divided map data, and determine, from S candidate lanes, the target lane to which the target vehicle belongs.

The S pieces of divided map data include divided map data Lᵢ, and i is a positive integer less than or equal to S.

The lane determining unit 134 includes: a lane obtaining subunit 1341, a weight determining subunit 1342, and a lane determining subunit 1343.

The lane obtaining subunit 1341 is configured to: determine a maximum lane probability in a lane probability respectively corresponding to at least one lane of the divided map data Lᵢ as a candidate probability corresponding to the divided map data Lᵢ, and determine a lane with a maximum lane probability in the at least one lane of the divided map data Lᵢ as a candidate lane corresponding to the divided map data Lᵢ;
the weight determining subunit 1342 is configured to: obtain a longitudinal average distance between the target vehicle and each of the S pieces of divided map data, and determining, according to a nearest road visible point and S longitudinal average distances, region weights respectively corresponding to the S pieces of divided map data.

The divided map data Lᵢ includes a region upper boundary and a region lower boundary. In the driving direction, a road location indicated by the region upper boundary is in front of a road location indicated by the region lower boundary.

The weight determining subunit 1342 is further configured to: determine an upper boundary distance between the target vehicle and the road location indicated by the region upper boundary of the divided map data Lᵢ, and determine a lower boundary distance between the target vehicle and the road location indicated by the region lower boundary of the divided map data Lᵢ; and
the weight determining subunit 1342 is further configured to determine an average value of the upper boundary distance corresponding to the divided map data Lᵢ and the lower boundary distance corresponding to the divided map data Lᵢ as a longitudinal average distance between the target vehicle and the divided map data Lᵢ.

The weight determining subunit 1342 is configured to multiply a candidate probability by a region weight that belong to same divided map data to obtain S trusted weights respectively corresponding to the divided map data; and
the lane determining subunit 1343 is configured to determine a candidate lane corresponding to a maximum trusted weight of the S trusted weights as the target lane to which the target vehicle belongs.

For specific implementations of the lane obtaining subunit 1341, the weight determining subunit 1342, and the lane determining subunit 1343, refer to descriptions of operation S1034 in the foregoing embodiment corresponding to FIG. 3. Details are not described herein again.

For specific implementations of the region division unit 131, the lane identification unit 132, the data matching unit 133, and the lane determining unit 134, refer to the descriptions of operation S1031 to operation S1034 in the foregoing embodiment corresponding to FIG. 8. Details are not described herein again.

In some embodiments, the boundary determining module 14 is configured to determine, according to the component parameter of the photographing component, M photographing boundary lines corresponding to the photographing component; M being a positive integer; the M photographing boundary lines including a lower boundary line; and the lower boundary line being a boundary line that is in the M photographing boundary lines and that is closest to a road.

The component parameter of the photographing component includes a vertical visible angle and a component location parameter; the vertical visible angle refers to a photographing angle of the photographing component in a direction perpendicular to the ground plane; the component location parameter refers to an installation location and an installation direction of the photographing component installed on the target vehicle; and the M photographing boundary lines further include an upper boundary line.

The boundary line determining module 14 is further configured to determine a primary optical axis of the photographing component according to the installation location and the installation direction in the component location parameter;
the boundary line determining module 14 is further configured to evenly divide the vertical visible angle to obtain an average vertical visible angle of the photographing component; and
the boundary line determining module 14 is further configured to obtain, along the primary optical axis, the lower boundary line and the upper boundary line that form the average vertical visible angle with the primary optical axis; where the primary optical axis, the upper boundary line, and the lower boundary line are located on a same plane, and the plane on which the primary optical axis, the upper boundary line, and the lower boundary line are located is perpendicular to the ground plane.

The road point determining module 15 is configured to: obtain a ground plane in which the target vehicle is located, and determine an intersection point of the ground plane and the lower boundary line as a candidate road point corresponding to the lower boundary line;
the road point determining module 15 is configured to: determine a target tangent formed by the photographing component and a vehicle head boundary point of the target vehicle, and determine an intersection point of the ground plane and the target tangent as a candidate road point corresponding to the target tangent; and
the visible region determining module 16 is configured to determine, from a candidate road point corresponding to the lower boundary line and a candidate road point corresponding to the target tangent, a candidate road point relatively far from the target vehicle as the road visible region corresponding to the target vehicle.

For specific implementations of the visual region obtaining module 11, the data obtaining module 12, and the lane determining module 13, refer to descriptions of operation S101 to operation S103 in the foregoing embodiment corresponding to FIG. 3 and operation S1031 to operation S1034 in the foregoing embodiment corresponding to FIG. 8. Details are not described herein again. For specific implementations of the boundary line determining module 14, the road point determining module 15, and the visual region determining module 16, refer to descriptions of operation S101 in the foregoing embodiment corresponding to FIG. 3. Details are not described herein again. In addition, the description of beneficial effects of the same method are not described herein again.

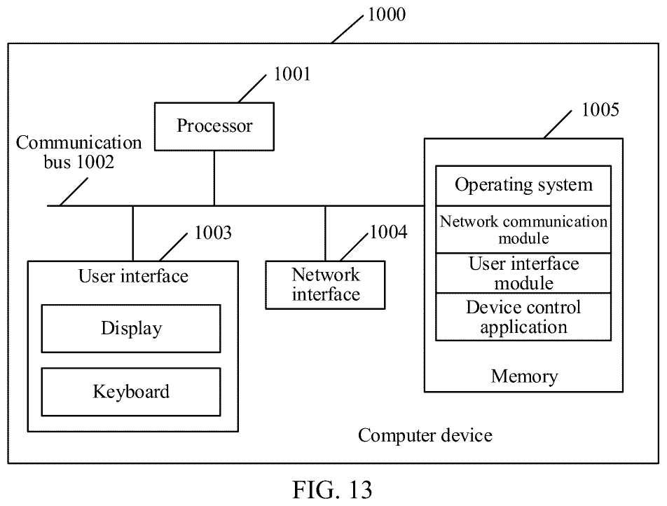

Further, referring to FIG. 13, FIG. 13 is a schematic structural diagram of a computer device according to an embodiment of the present disclosure. The computer device may be an in-vehicle terminal or a server. As shown in FIG. 13, the computer device 1000 may include: a processor 1001, a network interface 1004, and a memory 1005. In addition, the computer device 1000 may further include: a user interface 1003 and at least one communication bus 1002. The communication bus 1002 is configured to implement connection and communication between these components. In some embodiments, the user interface 1003 may include a display and a keyboard. In one embodiment, the user interface 1003 may further include a standard wired interface and wireless interface. In one embodiment, the network interface 1004 may include a standard wired interface and a standard wireless interface (such as a Wi-Fi interface). The memory 1005 may be a high-speed RAM memory, or may be a non-volatile memory, for example, at least one magnetic disk memory. In one embodiment, the memory 1005 may alternatively be at least one storage apparatus located away from the processor 1001. As shown in FIG. 13, the memory 1005 used as a computer storage medium may include an operating system, a network communications module, a user interface module, and a device-control application program.

In the computer device 1000 shown in FIG. 13, the network interface 1004 may provide a network communication function. The user interface 1003 is mainly configured to provide an input interface for a user. The processor 1001 may be configured to invoke the device-control application program stored in the memory 1005 to implement:
obtaining a road visible region corresponding to a target vehicle; the road visible region being related to the target vehicle and a component parameter of a photographing component installed on the target vehicle, and being a road location photographed by the photographing component;
obtaining, according to vehicle location status information of the target vehicle and the road visible region, local map data associated with the target vehicle; the road visible region being located in the local map data; the local map data including at least one lane associated with the target vehicle; and
determining, from the at least one lane of the local map data, a target lane to which the target vehicle belongs.

The computer device 1000 described in this embodiment of the present disclosure may perform the foregoing description of the lane positioning method in the embodiment corresponding to FIG. 3 or FIG. 8, or may perform the foregoing description of the lane positioning apparatus 1 in the embodiment corresponding to FIG. 12. Details are not described herein again. In addition, the description of beneficial effects of the same method are not described herein again.

In addition, an embodiment of the present disclosure further provides a computer readable storage medium, and the computer readable storage medium stores a computer program executed by the foregoing lane positioning apparatus 1. When a processor executes the computer program, the foregoing description of the lane positioning method in the embodiment corresponding to FIG. 3 or FIG. 8 can be executed. Therefore, details are not described herein again. In addition, the description of beneficial effects of the same method are not described herein again. For technical details that are not disclosed in the computer readable storage medium embodiments of the present disclosure, refer to the descriptions of the method embodiments of the present disclosure.

In addition, an embodiment of the present disclosure further provides a computer program product, where the computer program product includes a computer program, and the computer program may be stored in a computer readable storage medium. A processor of a computer device reads the computer program from the computer readable storage medium, and the processor may execute the computer program, so that the computer device executes the foregoing description of the lane positioning method in the embodiment corresponding to FIG. 3 or FIG. 8. Therefore, details are not described herein again. In addition, the description of beneficial effects of the same method are not described herein again. For technical details related to the computer program product embodiment in the present disclosure, refer to the description in the method embodiment of the present disclosure.

A person of ordinary skill in the art is to understand that all or a part of the processes of the method in the foregoing embodiment may be implemented by a program instructing relevant hardware. The program may be stored in a computer readable storage medium. When the program is run, the processes of the method in the foregoing embodiment are performed. The foregoing storage medium may include a magnetic disc, an optical disc, a read-only memory (ROM), a random access memory (RAM), or the like.

The embodiments of the present disclosure have the following beneficial effects. Accurate local map data may be obtained by comprehensively considering a road visible region corresponding to a target vehicle and vehicle location status information of the target vehicle, that is, because a visually-observed road location of the target vehicle is considered, the obtained local map data matches visually-observed map data of the target vehicle. That is, when a target lane to which the target vehicle belongs is determined in the local map data that matches the vision of the target vehicle, the target lane to which the target vehicle belongs may be accurately located, thereby increasing an accuracy rate of locating the target lane to which the target vehicle belongs, and further increasing an accuracy rate of lane-level positioning.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. A lane positioning method, performed by a computer device and comprising:
obtaining a road visible region corresponding to a target vehicle, the road visible region being related to the target vehicle and a component parameter of a photographing component installed on the target vehicle, and being a road location photographed by the photographing component;
obtaining, according to vehicle location status information of the target vehicle and the road visible region, local map data associated with the target vehicle, the road visible region being located in the local map data, and the local map data comprising at least one lane associated with the target vehicle; and
determining, from the at least one lane of the local map data, a target lane to which the target vehicle belongs.

2. The method according to claim 1, wherein obtaining the road visible region corresponding to the target vehicle comprises:
determining, according to the component parameter of the photographing component, M photographing boundary lines corresponding to the photographing component, M being a positive integer; the M photographing boundary lines comprising a lower boundary line; and the lower boundary line being a boundary line that is in the M photographing boundary lines and that is closest to a road;
obtaining a ground plane in which the target vehicle is located, and determining an intersection point of the ground plane and the lower boundary line as a candidate road point corresponding to the lower boundary line;
determining a target tangent formed by the photographing component and a vehicle head boundary point of the target vehicle, and determining an intersection point of the ground plane and the target tangent as a candidate road point corresponding to the target tangent; and
determining, from a candidate road point corresponding to the lower boundary line and a candidate road point corresponding to the target tangent, a candidate road point relatively far from the target vehicle as the road visible region corresponding to the target vehicle.

3. The method according to claim 2, wherein the component parameter of the photographing component comprises a vertical visible angle and a component location parameter; the vertical visible angle being a photographing angle of the photographing component in a direction perpendicular to the ground plane; the component location parameter referring to an installation location and an installation direction of the photographing component installed on the target vehicle; the M photographing boundary lines further comprising an upper boundary line; and
determining the M photographing boundary lines corresponding to the photographing component comprises:
determining a primary optical axis of the photographing component according to the installation location and the installation direction in the component location parameter;
evenly dividing the vertical visible angle to obtain an average vertical visible angle of the photographing component; and
obtaining, along the primary optical axis, the lower boundary line and the upper boundary line that form the average vertical visible angle with the primary optical axis, wherein the primary optical axis, the upper boundary line, and the lower boundary line are located on a same plane, and a plane on which the primary optical axis, the upper boundary line, and the lower boundary line are located is perpendicular to the ground plane.

4. The method according to claim 1, wherein obtaining the local map data associated with the target vehicle comprises:
obtaining a vehicle location point of the target vehicle in the vehicle location status information of the target vehicle, and determining, according to the vehicle location point, a circular error probable corresponding to the target vehicle;
determining a distance between the road visible region and the target vehicle as a road visible point distance;
determining, according to the vehicle location status information, the circular error probable, and the road visible point distance, a region upper limit corresponding to the target vehicle and a region lower limit corresponding to the target vehicle; and
determining, from global map data, map data between a road location indicated by the region upper limit and a road location indicated by the region lower limit as the local map data associated with the target vehicle, the road location indicated by the region upper limit being located in front of the target vehicle in a driving direction; and in the driving direction, the road location indicated by the region upper limit being in front of the road location indicated by the region lower limit.

5. The method according to claim 4, wherein the vehicle location status information further comprises a vehicle driving state of the target vehicle at the vehicle location point; and
determining the region upper limit corresponding to the target vehicle and the region lower limit corresponding to the target vehicle comprises:
performing first operation processing on the circular error probable and the road visible point distance to obtain the region lower limit corresponding to the target vehicle; and
extending, by using the vehicle driving state, the road visible point distance along the driving direction to obtain an extended visible point distance, and performing second operation processing on the extended visible point distance and the circular error probable to obtain the region upper limit corresponding to the target vehicle.

6. The method according to claim 1, wherein the vehicle location status information comprises a vehicle driving state of the target vehicle; and
obtaining the local map data associated with the target vehicle comprises:
determining a distance between the road visible region and the target vehicle as a road visible point distance, and determining the road visible point distance as a region lower limit corresponding to the target vehicle;
extending, by using the vehicle driving state, the road visible point distance along the driving direction to obtain an extended visible point distance, and determining the extended visible point distance as a region upper limit corresponding to the target vehicle; and
determining, from global map data, map data between a road location indicated by the region upper limit and a road location indicated by the region lower limit as the local map data associated with the target vehicle; the road location indicated by the region upper limit being located in front of the target vehicle in a driving direction; and in the driving direction, the road location indicated by the region upper limit being in front of the road location indicated by the region lower limit.

7. The method according to claim 4, wherein determining, from the global map data, the map data between the road location indicated by the region upper limit and the road location indicated by the region lower limit as the local map data associated with the target vehicle comprises:
determining, from the global map data, a map location point corresponding to the vehicle location status information;
determining, from the global map data according to the map location point and the region lower limit, a road location indicated by the region lower limit;
determining, from the global map data according to the map location point and the region upper limit, a road location indicated by the region upper limit; and
determining map data between the road location indicated by the region lower limit and a road location indicated by the region upper limit as the local map data associated with the target vehicle; the local map data belonging to the global map data.

8. The method according to claim 6, wherein determining, from the global map data, the map data between the road location indicated by the region upper limit and the road location indicated by the region lower limit as the local map data associated with the target vehicle comprises:
determining, from the global map data, a map location point corresponding to the vehicle location status information;
determining, from the global map data according to the map location point and the region lower limit, a road location indicated by the region lower limit;
determining, from the global map data according to the map location point and the region upper limit, a road location indicated by the region upper limit; and
determining map data between the road location indicated by the region lower limit and a road location indicated by the region upper limit as the local map data associated with the target vehicle; the local map data belonging to the global map data.

9. The method according to claim 1, wherein determining the target lane to which the target vehicle belongs comprises:
performing region division on the local map data according to an appearance change point and a lane quantity change point, to obtain S pieces of divided map data in the local map data, S being a positive integer; a quantity of map lane lines in a same divided map data being fixed, and a map lane line pattern type and a map lane line color on a same lane line in same divided map data being fixed; and the appearance change point referring to a location at which the map lane line pattern type or the map lane line color on the same lane line in the local map data changes, and the lane quantity change point referring to a location at which the map lane line color in the local map data changes;
obtaining lane line observation information corresponding to a lane line photographed by the photographing component;
separately matching the lane line observation information and the vehicle location status information with the S pieces of divided map data to obtain a lane probability respectively corresponding to at least one lane in each piece of divided map data; and
determining, according to a lane probability respectively corresponding to at least one lane in the S pieces of divided map data, a candidate lane corresponding to each piece of divided map data from the at least one lane respectively corresponding to each piece of divided map data, and determining, from S candidate lanes, the target lane to which the target vehicle belongs.

10. The method according to claim 9, wherein obtaining the lane line observation information corresponding to the lane line photographed by the photographing component comprises:
obtaining a road image that is photographed by the photographing component and that corresponds to a road in the driving direction;
performing element segmentation on the road image to obtain a lane line in the road image; and
performing attribute identification on the lane line to obtain the lane line observation information corresponding to the lane line.

11. The method according to claim 10, wherein the lane line observation information comprises a lane line color corresponding to the lane line and a lane line pattern type corresponding to the lane line; and
performing the attribute identification on the lane line to obtain the lane line observation information corresponding to the lane line comprises:
inputting the lane line to an attribute identification model, and performing feature extraction on the lane line by using the attribute identification model to obtain a color attribute feature corresponding to the lane line and a pattern type attribute feature corresponding to the lane line; and
determining the lane line color according to the color attribute feature corresponding to the lane line, and determining the lane line pattern type according to the pattern type attribute feature corresponding to the lane line, the lane line color being configured for matching with a map lane line color in the local map data, and the lane line pattern type being configured for matching with a map lane line pattern type in the local map data.

12. The method according to claim 10, wherein a quantity of the lane lines is at least two; the lane line observation information comprises a lane line equation; and
performing the attribute identification on the lane line to obtain the lane line observation information corresponding to the lane line comprises:
performing a reverse perspective change on the at least two lane lines to obtain changed lane lines respectively corresponding to the at least two lane lines; and
separately performing fitting reconstruction on the at least two changed lane lines to obtain the lane line equation respectively corresponding to each changed lane line, the lane line equation being configured for matching with shape point coordinates in the local map data; and the shape point coordinates in the local map data being configured for fitting a road shape of at least one lane in the local map data.

13. The method according to claim 9, wherein the S pieces of divided map data comprise divided map data Lᵢ, and i is a positive integer less than or equal to S; and
determining the candidate lane corresponding to each piece of divided map data and determining the target lane to which the target vehicle belongs comprises:
determining a maximum lane probability in a lane probability respectively corresponding to at least one lane of the divided map data Lᵢ as a candidate probability corresponding to the divided map data Lᵢ, and determining a lane with a maximum lane probability in the at least one lane of the divided map data Lᵢ as a candidate lane corresponding to the divided map data Lᵢ;
obtaining a longitudinal average distance between the target vehicle and each of the S pieces of divided map data, and determining, according to a nearest road visible point and S longitudinal average distances, region weights respectively corresponding to the S pieces of divided map data;
multiplying a candidate probability by a region weight that belong to same divided map data to obtain S trusted weights respectively corresponding to the divided map data; and
determining a candidate lane corresponding to a maximum trusted weight of the S trusted weights as the target lane to which the target vehicle belongs.

14. The method according to claim 13, wherein the divided map data Lᵢ comprises a region upper boundary and a region lower boundary; in the driving direction, a road location indicated by the region upper boundary is in front of a road location indicated by the region lower boundary; and
obtaining the longitudinal average distance between the target vehicle and each of the S pieces of divided map data comprises:
determining an upper boundary distance between the target vehicle and the road location indicated by the region upper boundary of the divided map data Lᵢ, and determining a lower boundary distance between the target vehicle and the road location indicated by the region lower boundary of the divided map data Lᵢ; and
determining an average value of the upper boundary distance corresponding to the divided map data Lᵢ and the lower boundary distance corresponding to the divided map data Lᵢ as a longitudinal average distance between the target vehicle and the divided map data Lᵢ.

15. A computer device, comprising: at least one processor and a memory storing a computer program that, when being executed, causes the at least one processor to perform:
obtaining a road visible region corresponding to a target vehicle, the road visible region being related to the target vehicle and a component parameter of a photographing component installed on the target vehicle, and being a road location photographed by the photographing component;
obtaining, according to vehicle location status information of the target vehicle and the road visible region, local map data associated with the target vehicle, the road visible region being located in the local map data, and the local map data comprising at least one lane associated with the target vehicle; and
determining, from the at least one lane of the local map data, a target lane to which the target vehicle belongs.

16. The device according to claim 15, wherein the at least one processor is further configured to perform:
determining, according to the component parameter of the photographing component, M photographing boundary lines corresponding to the photographing component, M being a positive integer; the M photographing boundary lines comprising a lower boundary line; and the lower boundary line being a boundary line that is in the M photographing boundary lines and that is closest to a road;
obtaining a ground plane in which the target vehicle is located, and determining an intersection point of the ground plane and the lower boundary line as a candidate road point corresponding to the lower boundary line;
determining a target tangent formed by the photographing component and a vehicle head boundary point of the target vehicle, and determining an intersection point of the ground plane and the target tangent as a candidate road point corresponding to the target tangent; and
determining, from a candidate road point corresponding to the lower boundary line and a candidate road point corresponding to the target tangent, a candidate road point relatively far from the target vehicle as the road visible region corresponding to the target vehicle.

17. The device according to claim 16, wherein the component parameter of the photographing component comprises a vertical visible angle and a component location parameter; the vertical visible angle being a photographing angle of the photographing component in a direction perpendicular to the ground plane; the component location parameter referring to an installation location and an installation direction of the photographing component installed on the target vehicle; the M photographing boundary lines further comprising an upper boundary line; and
the at least one processor is further configured to perform:
determining a primary optical axis of the photographing component according to the installation location and the installation direction in the component location parameter;
evenly dividing the vertical visible angle to obtain an average vertical visible angle of the photographing component; and
obtaining, along the primary optical axis, the lower boundary line and the upper boundary line that form the average vertical visible angle with the primary optical axis, wherein the primary optical axis, the upper boundary line, and the lower boundary line are located on a same plane, and a plane on which the primary optical axis, the upper boundary line, and the lower boundary line are located is perpendicular to the ground plane.

18. The device according to claim 15, wherein the at least one processor is further configured to perform:
obtaining a vehicle location point of the target vehicle in the vehicle location status information of the target vehicle, and determining, according to the vehicle location point, a circular error probable corresponding to the target vehicle;
determining a distance between the road visible region and the target vehicle as a road visible point distance;
determining, according to the vehicle location status information, the circular error probable, and the road visible point distance, a region upper limit corresponding to the target vehicle and a region lower limit corresponding to the target vehicle; and
determining, from global map data, map data between a road location indicated by the region upper limit and a road location indicated by the region lower limit as the local map data associated with the target vehicle, the road location indicated by the region upper limit being located in front of the target vehicle in a driving direction; and in the driving direction, the road location indicated by the region upper limit being in front of the road location indicated by the region lower limit.

19. The device according to claim 18, wherein the vehicle location status information further comprises a vehicle driving state of the target vehicle at the vehicle location point; and
the at least one processor is further configured to perform:
performing first operation processing on the circular error probable and the road visible point distance to obtain the region lower limit corresponding to the target vehicle; and
extending, by using the vehicle driving state, the road visible point distance along the driving direction to obtain an extended visible point distance, and performing second operation processing on the extended visible point distance and the circular error probable to obtain the region upper limit corresponding to the target vehicle.

20. A non-transitory computer readable storage medium containing a computer program that, when being executed, causes one or more processors of a computer device to perform:
obtaining a road visible region corresponding to a target vehicle, the road visible region being related to the target vehicle and a component parameter of a photographing component installed on the target vehicle, and being a road location photographed by the photographing component;
obtaining, according to vehicle location status information of the target vehicle and the road visible region, local map data associated with the target vehicle, the road visible region being located in the local map data, and the local map data comprising at least one lane associated with the target vehicle; and
determining, from the at least one lane of the local map data, a target lane to which the target vehicle belongs.
